(19) United States
(12) Patent Application Publication
(10) Pub. No.: US 2026/0089713 A1
(43) Pub. Date: Mar. 26, 2026

(54) METHOD AND APPARATUS FOR TRANSMITTING AND RECEIVING SIGNAL IN COMMUNICATION SYSTEM SUPPORTING SUBBAND FULL DUPLEX

(71) Applicant: Electronics and Telecommunications Research Institute, Daejeon (KR)

(72) Inventors: Hoiyoon JUNG, Daejeon (KR); Ji Hyung KIM, Daejeon (KR); Cheulsoon KIM, Daejeon (KR); Sung-Hyun MOON, Daejeon (KR); Junghoon LEE, Daejeon (KR)

(21) Appl. No.: 19/333,242

(22) Filed: Sep. 18, 2025

(30) Foreign Application Priority Data
Sep. 20, 2024 (KR) 10-2024-0127732
Nov. 7, 2024 (KR) 10-2024-0157184
Feb. 6, 2025 (KR) 10-2025-0015075
Mar. 27, 2025 (KR) 10-2025-0039421
Apr. 4, 2025 (KR) 10-2025-0044202
Apr. 23, 2025 (KR) 10-2025-0052917
Jun. 17, 2025 (KR) 10-2025-0079628
Sep. 16, 2025 (KR) 10-2025-0132910

(51) Int. Cl. H04W 72/1268; H04L 5/14

(52) U.S. Cl. CPC H04W 72/1268; H04L 5/14

(57) ABSTRACT

A method of a terminal may comprise: receiving, from a base station, scheduling information for a plurality of physical uplink shared channel (PUSCH) transmissions across subband full-duplex (SBFD) symbols and non-SBFD (N-SBFD) symbols; determining, based on the scheduling information, a first start physical resource block (PRB) for one or more PUSCH transmissions among the plurality of PUSCH transmissions in the SBFD symbols; and transmitting the one or more PUSCH transmissions to the base station using a first frequency resource based on the first start PRB in the SBFD symbols.

### CROSS-REFERENCE TO RELATED APPLICATIONS

This application claims priority to Korean Patent Applications No. 10-2024-0127732, filed on Sep. 20, 2024, No. 10-2024-0157184, filed on Nov. 7, 2024, No. 10-2025-0015075, filed on Feb. 6, 2025, No. 10-2025-0039421, filed on Mar. 27, 2025, No. 10-2025-0044202, filed on Apr. 4, 2025, No. 10-2025-0052917, filed on Apr. 23, 2025, No. 10-2025-0079628, filed on Jun. 17, 2025, and No. 10-2025-0132910, filed on Sep. 16, 2025, with the Korean Intellectual Property Office (KIPO), the entire contents of which are hereby incorporated by reference.

### BACKGROUND

### 1. Technical Field

The present disclosure relates to a technique for transmitting and receiving signals in a communication system, and more particularly, to a technique for transmitting and receiving signals in a communication supporting subband full-duplex (SBFD).

### 2. Related Art

With the advancement of information and communication technology, various wireless communication technologies have been developed. The representative wireless communication technologies may be long term evolution (LTE), LTE-advanced (LTE-A), new radio (NR), and the like specified as the 3^{rd} generation partnership project (3GPP) standards. The LTE and/or LTE-A may be 4^{th} generation (4G) communication technology. The NR may be a 5^{th} generation (5G) communication technology.

The 5G communication system (e.g., communication system supporting the NR) using a higher frequency band (e.g., a frequency band of 6 GHz or above) than a frequency band (e.g., a frequency band of 6 GHz or below) of the 4G communication system is being considered for processing of soaring wireless data after commercialization of the 4G communication system (e.g., communication system supporting the LTE and/or LTE-A). The 5G communication system may support enhanced Mobile BroadBand (eMBB), Ultra Reliable Low Latency Communication (URLLC), and/or Massive Machine Type Communication (mMTC).

A communication system (e.g., 5G communication system) may support subband full-duplex (SBFD) in order to improve efficiency and performance of a communication network. In the communication system supporting SBFD, uplink resource allocation may be performed differently from uplink resource allocation in a communication system supporting half duplex (HD). A terminal may determine a duplex scheme (e.g., SBFD scheme or HD scheme) of a transmission signal. The terminal may transmit an uplink signal in an uplink resource based on the determined duplex scheme. In order to support the above operation, methods for transmitting and receiving a signal (e.g., SBFD signal) in the communication system supporting SBFD may be required.

Meanwhile, the above-described technologies are described to enhance the understanding of the background of the present disclosure, and they may include non-prior arts that are not already known to those of ordinary skill in the art.

### SUMMARY

The present disclosure for resolving the above-described problems is directed to providing methods and apparatuses for signal transmission and reception in a communication system supporting subband full-duplex (SBFD).

A method of a terminal, according to exemplary embodiments of the present disclosure, may comprise: receiving, from a base station, scheduling information for a plurality of physical uplink shared channel (PUSCH) transmissions across subband full-duplex (SBFD) symbols and non-SBFD (N-SBFD) symbols; determining, based on the scheduling information, a first start physical resource block (PRB) for one or more PUSCH transmissions among the plurality of PUSCH transmissions in the SBFD symbols; and transmitting the one or more PUSCH transmissions to the base station using a first frequency resource based on the first start PRB in the SBFD symbols.

The SBFD symbols and the N-SBFD symbols may be located in different slots.

The SBFD symbols and the N-SBFD symbols may be located in a same slot, and the plurality of PUSCH transmissions may be based on PUSCH repetition type B.

The method may further comprise: determining, based on the scheduling information, a second frequency resource for at least one PUSCH transmission among the plurality of PUSCH transmissions in the N-SBFD symbols; and transmitting the at least one PUSCH transmission to the base station using the second frequency resource of the N-SBFD symbols.

A size of the first frequency resource may be same as a size of the second frequency resource, and the first start PRB of the first frequency resource may be different from a second start PRB of the second frequency resource.

The scheduling information may include a bitmap indicating the second frequency resource for the at least one PUSCH transmission in the N-SBFD symbols.

The first start PRB may be determined based on S=U+(N+O) mod A, S denotes an index of the first start PRB, U denotes an index of a start PRB of uplink (UL) usable PRBs, N denotes an index of a second start PRB of the second frequency resource in the N-SBFD symbols, O denotes a frequency offset, and A denotes a number of PRBs included in the UL usable PRBs.

The frequency offset may be independently configured for the terminal according to a type of a configured grant (CG) PUSCH transmission.

The determining of the first start PRB may comprise: determining the first start PRB in a first hop or the first start PRB in a second hop based on that the one or more PUSCH transmissions are performed based on a frequency hopping scheme.

The frequency hopping scheme may be an intra-slot frequency hopping scheme for the one or more PUSCH transmissions in the SBFD symbols.

The first start PRB in the second hop may be determined based on S=U+(K−U−O) mod L, S denotes an index of the first start PRB in the second hop, U denotes an index of a start PRB of UL usable PRBs, K denotes an index of the first start PRB in the first hop, O denotes a frequency offset, and L denotes a number of PRBs included in the UL usable PRBs.

When an SBFD transmission/reception configuration 2 is indicated to the terminal, K may denote a PRB index after the frequency offset from a start of a UL active bandwidth part (BWP).

A terminal according to exemplary embodiments of the present disclosure may comprise at least one processor, and the at least one processor may cause the terminal to perform: receiving, from a base station, scheduling information for a plurality of physical uplink shared channel (PUSCH) transmissions across subband full-duplex (SBFD) symbols and non-SBFD (N-SBFD) symbols; determining, based on the scheduling information, a first start physical resource block (PRB) for one or more PUSCH transmissions among the plurality of PUSCH transmissions in the SBFD symbols; and transmitting the one or more PUSCH transmissions to the base station using a first frequency resource based on the first start PRB in the SBFD symbols.

The at least one processor may further cause the terminal to perform: determining, based on the scheduling information, a second frequency resource for at least one PUSCH transmission among the plurality of PUSCH transmissions in the N-SBFD symbols; and transmitting the at least one PUSCH transmission to the base station using the second frequency resource of the N-SBFD symbols.

A size of the first frequency resource may be same as a size of the second frequency resource, and the first start PRB of the first frequency resource may be different from a second start PRB of the second frequency resource.

The first start PRB may be determined based on S=U+(N+O) mod A, S denotes an index of the first start PRB, U denotes an index of a start PRB of uplink (UL) usable PRBs, N denotes an index of a second start PRB of the second frequency resource in the N-SBFD symbols, O denotes a frequency offset, and A denotes a number of PRBs included in the UL usable PRBs.

The frequency offset may be independently configured for the terminal according to a type of a configured grant (CG) PUSCH transmission.

In the determining of the first start PRB, the at least one processor may further cause the terminal to perform: determining the first start PRB in a first hop or the first start PRB in a second hop based on that the one or more PUSCH transmissions are performed based on a frequency hopping scheme.

The first start PRB in the second hop may be determined based on S=U+(K−U−O) mod L, S denotes an index of the first start PRB in the second hop, U denotes an index of a start PRB of UL usable PRBs, K denotes an index of the first start PRB in the first hop, O denotes a frequency offset, and L denotes a number of PRBs included in the UL usable PRBs.

When an SBFD transmission/reception configuration 2 is indicated to the terminal, K may denote a PRB index after the frequency offset from a start of a UL active bandwidth part (BWP).

According to the present disclosure, a terminal can transmit a plurality of physical uplink shared channel (PUSCH) transmissions across SBFD symbols and non-SBFD (N-SBFD) symbols to a base station. The terminal can determine a start PRB of one or more PUSCH transmissions among the plurality of PUSCH transmissions in SBFD symbols, and may transmit the one or more PUSCH transmissions to the base station in frequency resources based on the determined start PRB. In addition, the terminal may determine a start PRB in a first hop and a start PRB in a second hop for one or more PUSCH transmissions in SBFD symbols, and may transmit the one or more PUSCH transmissions to the base station in frequency resources based on the determined start PRBs. Based on the above operations, uplink communication in a communication system supporting SBFD can be efficiently performed, and performance of the communication system can be improved.

### BRIEF DESCRIPTION OF DRAWINGS

FIG. 1 is a conceptual diagram illustrating a first exemplary embodiment of a communication network.

FIG. 2 is a block diagram illustrating a first exemplary embodiment of a communication node constituting a communication network.

FIG. 3 is a conceptual diagram illustrating a first exemplary embodiment of a system frame in a communication network.

FIG. 4 is a conceptual diagram illustrating a first exemplary embodiment of a subframe in a communication network.

FIG. 5 is a conceptual diagram illustrating a first exemplary embodiment of a slot in a communication network.

FIG. 6 is a conceptual diagram illustrating exemplary embodiments of a resource structure for SBFD communication in a communication network.

FIG. 7 is a conceptual diagram illustrating exemplary embodiments of UL usable PRBs in SBFD symbols in a communication network.

FIG. 8 is a conceptual diagram illustrating exemplary embodiments of a PUSCH scheduling method in a communication network.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re)transmission” may mean “transmission”, “retransmission”, or “transmission and retransmission”, “(re)configuration” may mean “configuration”, “reconfiguration”, or “configuration and reconfiguration”, “(re)connection” may mean “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication network to which the exemplary embodiments according to the present disclosure are applied is not limited to the contents described below, and the exemplary embodiments according to the present disclosure may be applied to various communication networks. Here, the communication network may be used in the same sense as a communication system. A communication network may refer to a wireless communication network, and a communication system may refer to a wireless communication system.

In the present disclosure, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. In the present disclosure, signaling may be at least one of system information (SI) signaling (e.g., transmission of system information block (SIB) and/or master information block (MIB)), RRC signaling (e.g., transmission of RRC parameters and/or higher-layer parameters), MAC control element (CE) signaling, or PHY signaling (e.g., transmission of downlink control information (DCI), uplink control information (UCI), and/or sidelink control information (SCI)). A message for SI signaling may be referred to as an SI message, a message for RRC signaling may be referred to as an RRC message, a message for MAC CE signaling may be referred to as a MAC message, and a message for PHY signaling may be referred to as a PHY message. The above messages may be expressed as a first message, a second message, a third message, and so on.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

In the present disclosure, time may mean a time point, and a time point may mean time. Time and a time point may be used in the same sense. A reception time of a signal or a channel may mean a reception start time or a reception end time. A transmission time of a signal or a channel may mean a transmission start time or a transmission end time. A signal/channel may mean a signal, a channel, or a signal and a channel. A signal may be interpreted as a signal, a channel, or a signal and a channel depending on context. A channel may be interpreted as a signal, a channel, or a signal and a channel depending on context. A communication node may be interpreted as a base station, a terminal, or a base station and a terminal depending on context.

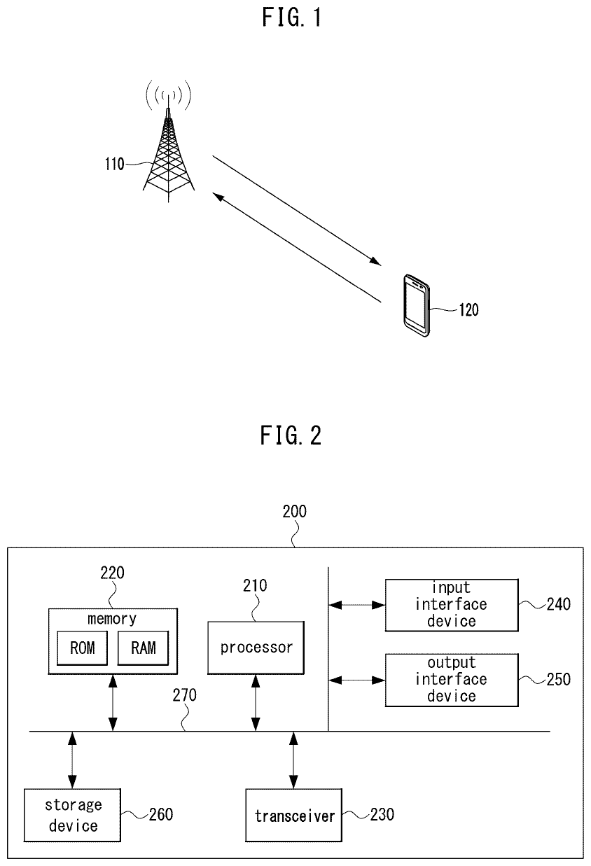

FIG. 1 is a conceptual diagram illustrating a first exemplary embodiment of a communication network.

Referring to FIG. 1, a base station 110 may support cellular communication (e.g., long term evolution (LTE), LTE-advance (LTE-A), LTE-A Pro, LTE-unlicensed (LTE-U), new radio (NR), and NR-unlicensed (NR-U) specified as the 3^{rd} generation partnership project (3GPP) standards), or the like. The base station 110 may support multiple-input multiple-output (MIMO) (e.g., single-user MIMO (SU-MIMO), multi-user MIMO (MU-MIMO), massive MIMO, etc.), coordinated multipoint (CoMP), carrier aggregation (CA), or the like. The terminal 120 may perform communication (e.g., uplink communication and/or downlink communication) with the base station 110.

The communication node (i.e., base station, terminal, etc.) constituting the communication network described above may support a code division multiple access (CDMA) based communication protocol, a wideband CDMA (WCDMA) based communication protocol, a time division multiple access (TDMA) based communication protocol, a frequency division multiple access (FDMA) based communication protocol, a single carrier-FDMA (SC-FDMA) based communication protocol, an orthogonal frequency division multiplexing (OFDM) based communication protocol, an orthogonal frequency division multiple access (OFDMA) based communication protocol, or the like.

Among the communication nodes, the base station may be referred to as a Node B, evolved Node B, 5G Node B (gNodeB), base transceiver station (BTS), radio base station, radio transceiver, access point, access node, transmission/reception point (Tx/Rx Point), or the like. Among the communication nodes, the terminal may be referred to as a user equipment (UE), access terminal, mobile terminal, station, subscriber station, portable subscriber station, mobile station, node, device, or the like. The communication node may have the following structure.

FIG. 2 is a block diagram illustrating a first exemplary embodiment of a communication node constituting a communication network.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Hereinafter, operation methods of a communication node in a communication network will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a first terminal (e.g., transmitting terminal) is described, a corresponding second terminal (e.g., receiving terminal) may perform an operation corresponding to the operation of the first terminal. Conversely, when an operation of the second terminal is described, the corresponding first terminal may perform an operation corresponding to the operation of the second terminal.

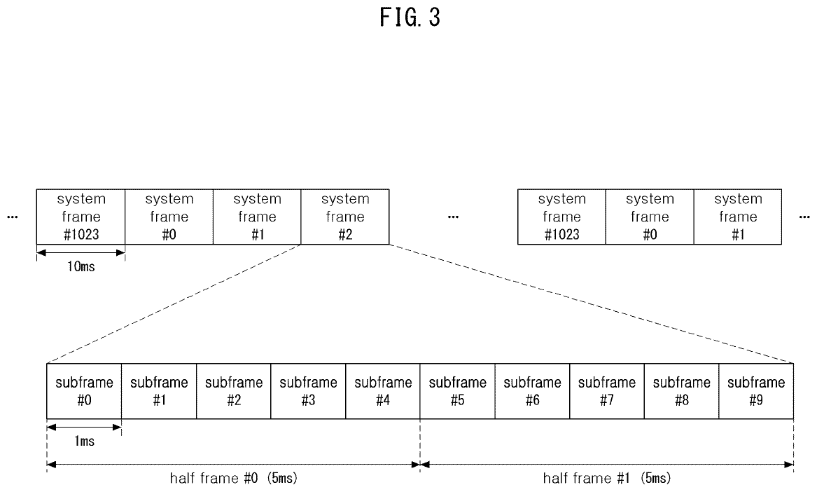

FIG. 3 is a conceptual diagram illustrating a first exemplary embodiment of a system frame in a communication network.

Referring to FIG. 3, time resources in a communication network may be divided into frames. For example, system frames each of which has a length of 10 milliseconds (ms) may be configured consecutively in the time domain of the communication network. System frame numbers (SFNs) may be set to #0 to #1023. In this case, 1024 system frames may be repeated in the time domain of the communication network. For example, an SFN of a system frame after the system frame #1023 may be set to #0.

One system frame may comprise two half frames, and the length of one half frame may be 5 ms. A half frame located in a starting region of a system frame may be referred to as a ‘half frame #0’, and a half frame located in an ending region of the system frame may be referred to as a ‘half frame #1’. The system frame may include 10 subframes, and the length of one subframe may be 1 ms. 10 subframes within one system frame may be referred to as ‘subframes #0 to #9’.

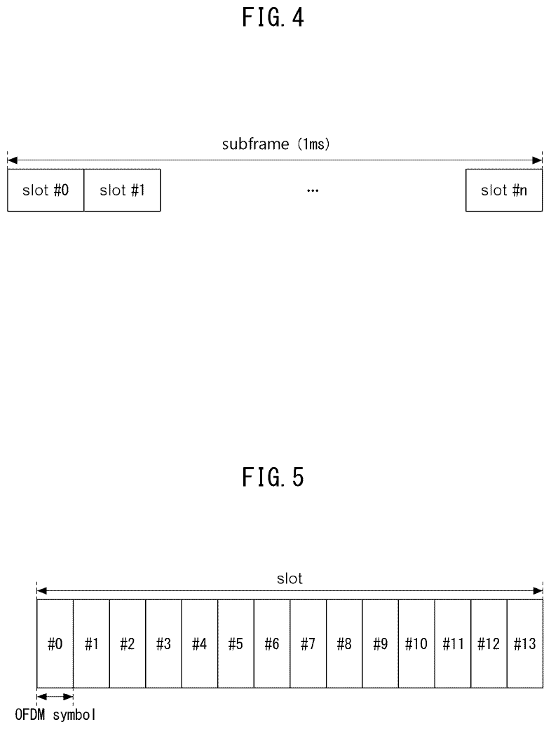

FIG. 4 is a conceptual diagram illustrating a first exemplary embodiment of a subframe in a communication network.

Referring to FIG. 4, one subframe may include n slots, and n may be a natural number. Accordingly, one subframe may be composed of one or more slots.

FIG. 5 is a conceptual diagram illustrating a first exemplary embodiment of a slot in a communication network.

Referring to FIG. 5, one slot may comprise one or more symbols. One slot shown in FIG. 5 may be composed of 14 symbols. Here, the length of the slot may vary depending on the number of symbols included in the slot and the length of the symbol. Alternatively, the length of the slot may vary according to a numerology. When a subcarrier spacing is 15 kHz (e.g., μ=0), the length of the slot may be 1 ms. In this case, one system frame may include 10 slots. When the subcarrier spacing is 30 kHz (e.g., μ=1), the length of the slot may be 0.5 ms. In this case, one system frame may include 20 slots.

When the subcarrier spacing is 60 kHz (e.g., μ=2), the length of the slot may be 0.25 ms. In this case, one system frame may include 40 slots. When the subcarrier spacing is 120 kHz (e.g., μ=3), the length of the slot may be 0.125 ms. In this case, one system frame may include 80 slots. When the subcarrier spacing is 240 kHz (e.g., =4), the length of the slot may be 0.0625 ms. In this case, one system frame may include 160 slots.

A symbol may be configured as a downlink (DL) symbol, a flexible (FL) symbol, or an uplink (UL) symbol. A slot consisting only of DL symbols may be referred to as a ‘DL slot’, a slot consisting only of FL symbols may be referred to as a ‘flexible (FL) slot’, and a slot consisting only of UL symbols may be referred to as a ‘UL slot’.

Reference signals may include a channel state information-reference signal (CSI-RS), a sounding reference signal (SRS), a demodulation-reference signal (DM-RS), or a phase tracking-reference signal (PT-RS). Channels may include a physical downlink control channel (PDCCH), a physical downlink shared channel (PDSCH), a physical uplink control channel (PUCCH), a physical uplink shared channel (PUSCH), a physical sidelink control channel (PSCCH), or a physical sidelink shared channel (PSSCH). In the present disclosure, a control channel may refer to a PDCCH, a PUCCH, or a PSCCH, and a data channel may refer to a PDSCH, a PUSCH, or a PSSCH.

Hereinafter, methods for transmitting and receiving data in a communication network will be described. In downlink communication, downlink data may be transmitted through a PDSCH. In uplink communication, uplink data may be transmitted through a PUSCH. In the present disclosure, a PDSCH may refer to downlink data or a resource in which the downlink data is transmitted and received, and a PUSCH may refer to uplink data or a resource in which the uplink data is transmitted and received. A base station may transmit downlink control information (DCI) including configuration information (e.g., resource allocation information, scheduling information) of a PDSCH on a PDCCH. In the present disclosure, a PDCCH may refer to a DCI (e.g., control information) or a resource in which the DCI is transmitted.

A terminal may receive the DCI on the PDCCH and identify the configuration information of the PDSCH included in the DCI. For example, the configuration information of the PDSCH may include time domain resource assignment (TDRA), frequency domain resource assignment (FDRA), information on a transmission resource of a feedback for the PDSCH, and/or modulation and coding scheme (MCS) information. The TDRA may indicate a resource region of the PDSCH in the time domain. The FDRA may indicate a resource region of the PDSCH in the frequency domain. The MCS information may indicate an MCS level or MCS index.

A base station may configure a bandwidth part (BWP) for downlink communication. The BWP may be configured differently for each terminal. The base station may notify the terminal of BWP configuration information through higher-layer signaling. The number of BWPs configured for one terminal may be one or more. The terminal may receive the BWP configuration information from the base station and may identify BWP(s) configured by the base station based on the BWP configuration information. When multiple BWPs are configured for downlink communication, the base station may activate one or more BWPs among the multiple BWPs. The base station may transmit configuration information of the activated BWP(s) to the terminal using at least one of higher-layer signaling, a medium access control (MAC) control element (CE), or a DCI. The base station may perform downlink communication using the activated BWP(s). The terminal may identify the activated BWP(s) by receiving the configuration information of the activated BWP(s) from the base station, and may perform downlink reception operations (e.g., downlink communication) in the activated BWP(s).

In the present disclosure, monitoring methods for PDCCH will be described. The terminal may perform a monitoring operation for a PDCCH in order to receive a PDSCH transmitted from the base station. The monitoring operation for the PDCCH may be referred to as a PDCCH monitoring operation. The base station may notify the terminal of configuration information for the PDCCH monitoring operation using a higher-layer message (e.g., radio resource control (RRC) message). The configuration information for the PDCCH monitoring operation may include control resource set (CORESET) information and/or search space information.

The CORESET information may include PDCCH demodulation reference signal (DMRS) information, precoding information for PDCCH, and PDCCH occasion information. The PDCCH DMRS may be a DMRS used to demodulate a PDCCH. The PDCCH occasion may be a region where a PDCCH may exist. In other words, the PDCCH occasion may be a region where a DCI may be transmitted. The PDCCH occasion information may include time resource information and/or frequency resource information of the PDCCH occasion. In the time domain, a length of the PDCCH occasion may be indicated in units of symbols. In the frequency domain, a size of the PDCCH occasion may be indicated in units of RBs (e.g., physical resource blocks (PRBs) or common resource blocks (CRBs)).

The search space information may include a CORESET identifier (ID) associated with a search space, a periodicity and/or offset of PDCCH monitoring, and the like. Each of the periodicity and offset of PDCCH monitoring may be indicated in units of slots. The search space information may further include an index of a symbol at which the PDCCH monitoring operation starts.

A communication network may perform communication based on a duplex scheme. A communication network may support a frequency division duplex (FDD) scheme. The communication network supporting the FDD scheme may use separate frequency bands for downlink communication and uplink communication. A communication network may support a time division duplex (TDD) scheme. The communication network supporting the TDD scheme may perform downlink communication or uplink communication by dividing time on the same frequency resource. Half-duplex (HD) communication may be performed in the communication network supporting the TDD scheme. The communication network supporting the HD scheme may perform either downlink communication or uplink communication in a time duration.

A communication network may perform full-duplex (FD) communication. The communication network supporting the FD scheme may perform downlink communication and uplink communication simultaneously in a time duration. In the communication network, FD communication may be performed by a base station. The base station may perform downlink communication and uplink communication simultaneously in a time duration. In the communication network, FD communication may be performed in divided frequency bands. For example, some frequency bands among frequency bands may be used for downlink communication, and other frequency bands among the frequency bands may be used for uplink communication. The FD communication described above may be referred to as subband full-duplex (SBFD) communication.

In the present disclosure, SBFD communication may refer to communication based on an SBFD scheme, FD communication may refer to communication based on the FD scheme, HD communication may refer to communication based on the HD scheme, FDD communication may refer to communication based on the FDD scheme, and TDD communication may refer to communication based on the TDD scheme. From the perspective of the base station, downlink communication may refer to downlink transmission, and uplink communication may refer to uplink reception. From the perspective of the terminal, downlink communication may refer to downlink reception, and uplink communication may refer to uplink transmission.

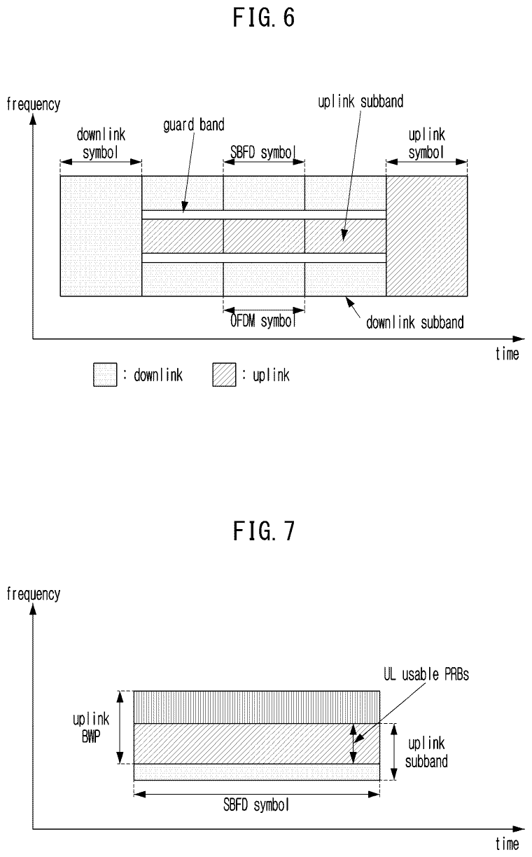

FIG. 6 is a conceptual diagram illustrating exemplary embodiments of a resource structure for SBFD communication in a communication network.

Referring to FIG. 6, in a communication network, a time resource may be configured in symbol units (e.g., OFDM symbol units). For example, a time resource may be configured as downlink symbol(s) (e.g., DL symbol(s)), uplink symbol(s) (e.g., UL symbol(s)), flexible symbol(s) (e.g., FL symbol(s)), and/or SBFD symbol(s). A downlink symbol may be a symbol in which downlink communication is performed. An uplink symbol may be a symbol in which uplink communication is performed. Downlink communication may be performed in some frequency regions of SBFD symbols, and uplink communication may be performed in other frequency regions of the SBFD symbols. The frequency regions of the SBFD symbols may be configured as a downlink subband (e.g., DL subband), an uplink subband (e.g., UL subband), and/or a guard band. In the SBFD symbols, the UL subband may also be referred to as an SBFD subband. Downlink communication may be performed in the downlink subband. One or more downlink subbands (e.g., one or two downlink subbands) may be configured in the SBFD symbols. Uplink communication may be performed in the uplink subband (e.g., SBFD subband). A guard band may exist between the uplink subband and the downlink subband. Transmission of a signal may not be performed in the guard band. One uplink subband may exist in the SBFD symbols. One or two downlink subbands may exist in the SBFD symbols.

In the communication network, SBFD symbols and/or SBFD subbands may be configured. The base station may transmit SBFD configuration information (e.g., SBFD symbol configuration information) to the terminal through signaling. The terminal may receive the SBFD configuration information (e.g., SBFD symbol configuration information) from the base station. The SBFD configuration information may include one or more of the following information.
Position of SBFD symbols in the time domain
Index of a start slot of SBFD symbols (e.g., SBFD subband) in the time domain
Index of a start symbol (e.g., start OFDM symbol) of the SBFD symbols in the start slot in the time domain
Index of an end slot of the SBFD symbols (e.g., SBFD subband) in the time domain
Index of an end symbol (e.g., end OFDM symbol) of the SBFD symbols in the end slot in the time domain
Position of a downlink subband for the SBFD symbols in the frequency domain
Start position of the downlink subband for the SBFD symbols in the frequency domain
Length (e.g., size, bandwidth) of the downlink subband for the SBFD symbols in the frequency domain
Position of an uplink subband (e.g., SBFD subband) for the SBFD symbols in the frequency domain
Start position of the uplink subband for the SBFD symbols in the frequency domain
Length (e.g., size, bandwidth) of the uplink subband for the SBFD symbols in the frequency domain
Position of a guard band for the SBFD symbols in the frequency domain
Start position of the guard band for the SBFD symbols in the frequency domain
Length (e.g., size, bandwidth) of the guard band for the SBFD symbols in the frequency domain

The time domain may refer to a time region, and the frequency domain may refer to a frequency region. A start slot of SBFD symbols (e.g., SBFD subband) may refer to a slot in which the first SBFD symbol is located in the time domain. A start symbol of the SBFD symbols may refer to a symbol in which the first SBFD symbol (e.g., the first SBFD symbol in the start slot of the SBFD symbols) is located in the time domain. The start slot may be the first slot, and the start symbol may be the first symbol. An end slot of the SBFD symbols (e.g., SBFD subband) may refer to a slot in which the last SBFD symbol is located in the time domain. An end symbol of the SBFD symbols may refer to a symbol in which the last SBFD symbol (e.g., the last SBFD symbol in the end slot of the SBFD symbols) is located in the time domain. The end slot may refer to the last slot, and the end symbol may refer to the last symbol. A symbol may refer to an OFDM symbol.

In the time domain, the position of SBFD symbols may be indicated based on a scheme of indicating symbol(s) corresponding to the SBFD symbols among symbols within a slot and/or a scheme of indicating whether each symbol in the slot corresponds to an SBFD symbol. In another method, positions of downlink symbols and uplink symbols within a slot may be indicated, and remaining symbol(s) within the slot not indicated as downlink symbol(s) or uplink symbol(s) may be regarded as SBFD symbol(s). The position of SBFD symbols within a slot in the time domain may be after downlink symbol(s). The position of SBFD symbols within a slot in the time domain may be before uplink symbol(s). The position of SBFD symbols within a slot in the time domain may be between a time duration in which downlink symbol(s) exist and a time duration in which uplink symbol(s) exist.

A base station may transmit TDD configuration information (e.g., tdd-UL-DL-ConfigurationCommon) to a terminal through signaling. The terminal may receive the TDD configuration information from the base station. The TDD configuration information may indicate positions of downlink symbols and/or flexible symbols. When an uplink subband is configured in downlink symbol(s) indicated by the TDD configuration information or when an uplink subband and a downlink subband are configured in flexible symbol(s) indicated by the TDD configuration information, the downlink symbol(s) or the flexible symbol(s) may be defined as SBFD symbol(s). The terminal may perform signal transmission (e.g., uplink communication) in SBFD symbols among the downlink symbols indicated by the TDD configuration information. When an uplink subband is not configured in downlink symbol(s) indicated by the TDD configuration information or when an uplink subband and a downlink subband are not configured in flexible symbol(s) indicated by the TDD configuration information, the downlink symbol(s) or the flexible symbol(s) may be defined as non-SBFD (N-SBFD) symbols. A symbol type may be determined as SBFD symbol or N-SBFD symbol. For example, the symbol type may be determined based on the TDD configuration information. The determined symbol type may not be updated (e.g., changed) by other information.

In the frequency domain, the position of the downlink subband for SBFD symbols may be indicated based on the lowest frequency position of the downlink subband (or a start position of the downlink subband in the frequency domain) and the length (e.g., size, bandwidth) of the downlink subband in the frequency domain. The downlink subband may be indicated in resource block (RB) units or subcarrier units. When one or more downlink subbands exist in SBFD symbols, the position(s) of one or more downlink subbands may be indicated to the terminal.

When a plurality of downlink subbands (e.g., downlink subband #1 and downlink subband #2) exist in SBFD symbols, the length (e.g., size, bandwidth) of the downlink subband #1 in the frequency domain and the length (e.g., size, bandwidth) of the downlink subband #2 in the frequency domain may be configured to be identical. The lowest frequency position of each of the plurality of downlink subbands or the start position of each of the plurality of downlink subbands in the frequency domain may be independently indicated to the terminal. The length of each of the plurality of downlink subbands in the frequency domain may be indicated to the terminal as one value.

In another example, when a plurality of downlink subbands (e.g., downlink subband #1 and downlink subband #2) exist in SBFD symbols, the length of the downlink subband #1 in the frequency domain and the length of the downlink subband #2 in the frequency domain may be configured independently from each other. In other words, the length of each of the plurality of downlink subbands in the frequency domain may be independently indicated to the terminal. The length of the downlink subband #1 may be the same as or different from the length of the downlink subband #2.

The position of an uplink subband (e.g., SBFD subband) for SBFD symbols in the frequency domain may be indicated based on the lowest frequency position of the uplink subband (or the start position of the uplink subband in the frequency domain) and the length (e.g., size, bandwidth) of the uplink subband in the frequency domain. The uplink subband may be indicated in RB units or subcarrier units.

The position of a guard band for SBFD symbols in the frequency domain may be determined based on the position of the downlink subband and the position of the uplink subband. For example, the communication node (e.g., base station and/or terminal) may regard (e.g., determine) the remaining frequency band in the frequency region excluding the downlink subband(s) and the uplink subband as a guard band.

The base station may transmit SBFD configuration information (e.g., SBFD symbol configuration information) to the terminal through a system information block (SIB). The SIB may be information transmitted in common to terminals in a cell. The base station may transmit the SBFD configuration information to the terminal through a higher layer message (e.g., RRC configuration). The higher layer message may be information transmitted to an individual terminal. Alternatively, the higher layer message may be information transmitted in common to terminals in a cell. The base station may transmit tdd-UL-DL-ConfigurationCommon including the SBFD configuration information to the terminal. The terminal may receive the SBFD configuration information through signaling of the base station, may identify (e.g., determine) SBFD symbols and/or N-SBFD symbols in the time domain based on the SBFD configuration information, and may identify (e.g., determine) downlink subband(s), an uplink subband, and/or a guard band for the SBFD symbols in the frequency domain based on the SBFD configuration information.

The base station may transmit the SBFD configuration information (e.g., SBFD symbol configuration information) to the terminal through the SIB and the higher layer message (e.g., RRC configuration). The terminal may receive the SIB from the base station and may identify the SBFD configuration information included in the SIB. The terminal may receive the higher layer message from the base station and may identify the SBFD configuration information included in the higher layer message. When the SBFD configuration information is received through the SIB and the higher layer message, the terminal may identify (e.g., determine) SBFD symbols, N-SBFD symbols, downlink subband(s) for the SBFD symbols, an uplink subband for the SBFD symbols, and/or a guard band for the SBFD symbols based on the SBFD configuration information received through the higher layer message. In other words, when SBFD configuration information is received through both the SIB and the higher layer message, the terminal may ignore the SBFD configuration information received through the SIB. The SBFD configuration information included in the higher layer message may take precedence over the SBFD configuration information included in the SIB.

The terminal may receive the SBFD configuration information and may identify SBFD symbols and N-SBFD symbols based on the SBFD configuration information. The terminal may receive a slot format indicator (SFI). The terminal may apply the SFI to the N-SBFD symbols. The terminal may not apply the SFI to the SBFD symbols. The terminal may ignore the SFI for the SBFD symbols.

Hereinafter, methods of transmitting and receiving signals in SBFD symbols and/or N-SBFD symbols are described. Among terminals, a terminal that can recognize SBFD symbols may refer to an SBFD-aware terminal. For convenience, the SBFD-aware terminal may be referred to as an SBFD terminal. Among terminals, a terminal that cannot recognize SBFD symbols may be referred to as a legacy terminal. In the present disclosure, a terminal may be interpreted as an SBFD terminal or a legacy terminal depending on context.

Uplink communication for an SBFD terminal may be performed in either SBFD symbols or N-SBFD symbols within one slot. In other words, uplink communication for an SBFD terminal may not be performed across SBFD symbols and N-SBFD symbols within one slot. The terminal may not expect an uplink channel/signal to be mapped across SBFD symbols and N-SBFD symbols within one slot. Downlink communication for an SBFD terminal may be performed in either SBFD symbols or N-SBFD symbols within one slot. In other words, downlink communication for an SBFD terminal may not be performed across SBFD symbols and N-SBFD symbols within one slot. The terminal may not expect a downlink channel/signal to be mapped across SBFD symbols and N-SBFD symbols within one slot. The SBFD terminal may not receive a PDSCH existing across SBFD symbols and N-SBFD symbols within one slot. Uplink communication and downlink communication for an SBFD terminal may respectively be performed in symbols of the same type within one slot. Uplink communication and downlink communication for an SBFD terminal may not be performed in symbols of different types within one slot.

Uplink communication (e.g., PUSCH transmission, PUCCH transmission) or downlink communication (e.g., PDSCH reception, PDCCH reception) may be scheduled in a plurality of slots (e.g., different slots), and each of the plurality of slots may include SBFD symbols and/or N-SBFD symbols. The SBFD terminal may determine whether to perform communication (e.g., uplink communication and/or downlink communication) across SBFD symbols and N-SBFD symbols in the plurality of slots based on a configuration of the base station.

The base station may indicate to the terminal through signaling (e.g., higher layer message, RRC configuration) a configuration indicating that communication is not performed across SBFD symbols and N-SBFD symbols in the plurality of slots (hereinafter referred to as ‘SBFD transmission/reception configuration 1’). An SBFD reception configuration 1 may indicate communication based on symbols having the same type in the plurality of slots. The SBFD transmission/reception configuration 1 may refer to the SBFD reception configuration 1 and/or an SBFD transmission configuration 1. The base station may indicate to the terminal through signaling (e.g., higher layer message, RRC configuration) a configuration indicating that communication is performed across SBFD symbols and N-SBFD symbols in the plurality of slots (hereinafter referred to as ‘SBFD transmission/reception configuration 2’). When the SBFD transmission/reception configuration 2 is indicated, the terminal may perform communication using SBFD symbols in one of the plurality of slots and may perform communication using N-SBFD symbols in another of the plurality of slots. The SBFD transmission/reception configuration 2 may refer to an SBFD reception configuration 2 and/or an SBFD transmission configuration 2.

The terminal may receive the SBFD transmission/reception configuration 1 or the SBFD transmission/reception configuration 2 based on signaling of the base station. A higher layer message indicating the SBFD transmission/reception configuration 1 or the SBFD transmission/reception configuration 2 may be configured for a cell (e.g., serving cell). In other words, the higher layer message indicating the SBFD transmission/reception configuration 1 or the SBFD transmission/reception configuration 2 may be configured cell-specifically. For example, the SBFD transmission/reception configuration 1 or the SBFD transmission/reception configuration 2 may be indicated commonly to terminals in a cell.

In another exemplary embodiment, the higher layer message indicating the SBFD transmission/reception configuration 1 or the SBFD transmission/reception configuration 2 may be configured UE-specifically. For example, the SBFD transmission/reception configuration 1 or the SBFD transmission/reception configuration 2 may be indicated for each terminal. In another exemplary embodiment, the higher layer message indicating the SBFD transmission/reception configuration 1 or the SBFD transmission/reception configuration 2 may be configured per channel or signal. For example, the SBFD transmission/reception configuration 1 or the SBFD transmission/reception configuration 2 may be indicated for each channel or signal transmitted and received by the terminal. In another exemplary embodiment, the higher layer message indicating the SBFD transmission/reception configuration 1 or the SBFD transmission/reception configuration 2 may be configured for each BWP (e.g., BWP of the terminal). For example, the SBFD transmission/reception configuration 1 or the SBFD transmission/reception configuration 2 may be indicated for a downlink BWP or uplink BWP. When one or more downlink BWPs and/or one or more uplink BWPs are configured for the terminal, the SBFD transmission/reception configuration 1 or the SBFD transmission/reception configuration 2 may be indicated for each of the BWPs.

The SBFD reception configuration 1 or the SBFD reception configuration 2 for a downlink BWP of the terminal may be indicated. The SBFD transmission configuration 1 or the SBFD transmission configuration 2 for an uplink BWP of the terminal may be indicated. An SBFD reception configuration may include a reception configuration among SBFD transmission and reception configurations. An SBFD transmission configuration may include a transmission configuration among SBFD transmission and reception configurations. When the SBFD transmission/reception configuration 1 or the SBFD transmission/reception configuration 2 is indicated for each BWP, the SBFD transmission/reception configuration may be applied for downlink communication (e.g., PDSCH reception, PDCCH reception) or uplink communication (e.g., PUSCH transmission, PUCCH transmission) in the BWP. The SBFD transmission/reception configuration 1 and/or the SBFD transmission/reception configuration 2 may not be applied for downlink communication and/or uplink communication performed outside the BWP.

A default SBFD transmission/reception configuration may be the SBFD transmission/reception configuration 1. When the SBFD transmission/reception configuration 1 is indicated by the base station, the terminal may perform communication based on the SBFD transmission/reception configuration 1. Alternatively, when the SBFD transmission/reception configuration 2 is not indicated by the base station, the terminal may perform communication based on the SBFD transmission/reception configuration 1 (e.g., default SBFD transmission/reception configuration). When the SBFD transmission/reception configuration 2 is indicated by the base station, the terminal may perform communication based on the SBFD transmission/reception configuration 2. When the terminal does not receive a separate SBFD transmission/reception configuration from the base station, the terminal may perform communication by using the SBFD transmission/reception configuration 1, which is the default SBFD transmission/reception configuration. The indication of the SBFD transmission/reception configuration 1 from the base station may mean that a separate SBFD transmission/reception configuration is not received from the base station. The indication of the SBFD transmission/reception configuration 1 from the base station may mean that the SBFD transmission/reception configuration 2 is not received from the base station.

In another exemplary embodiment, an SBFD transmission/reception configuration (e.g., SBFD transmission/reception configuration indicated by a higher layer message) may vary depending on a scheduling scheme. The scheduling scheme may be classified into a semi-static scheduling (SPS) scheme, a configured grant (CG) scheduling scheme, or a dynamic scheduling scheme. For example, for communication based on the SPS scheme or the CG scheduling scheme, the SBFD transmission/reception configuration 1 may be indicated to the terminal, and for communication based on the dynamic scheduling scheme, the SBFD transmission/reception configuration 2 may be indicated to the terminal.

For communication across SBFD symbols and N-SBFD symbols within a plurality of slots, the base station may indicate to the terminal to perform communication by using symbols (e.g., SBFD symbols or N-SBFD symbols) having the same type in each slot. The terminal may identify the indication of the base station. The communication node (e.g., base station and/or terminal) may perform communication by using SBFD symbols or N-SBFD symbols in each slot. The terminal may determine a symbol type for communication based on different criteria according to a scheduling scheme of the base station. Communication may be interpreted as uplink communication, downlink communication, or uplink communication and downlink communication depending on context. The symbol type for communication may be determined not only by the terminal but also by the base station. The base station may determine a symbol type for communication in a same or similar manner to the terminal and may perform communication with the terminal in one or more symbols having the determined symbol type.

The terminal may receive, from the base station, an indication of signal reception or signal transmission across SBFD symbols and N-SBFD symbols in one slot. In this case, the terminal may drop signal reception or signal transmission. Alternatively, the terminal may postpone signal reception or signal transmission. For example, the terminal may receive, from the base station, an indication (e.g., configuration, scheduling) of repeated PUCCH transmission or ‘TB processing over multiple slots (TBoMS)’ transmission across SBFD symbols and N-SBFD symbols in one slot. In this case, the terminal may postpone (or drop) the repeated PUCCH transmission or the TBoMS transmission. In another example, the terminal may receive, from the base station, an indication (e.g., configuration, scheduling) of CG-based PUSCH transmission, periodic SRS transmission, semi-persistent SRS transmission, periodic PUCCH transmission, or semi-persistent PUCCH transmission across SBFD symbols and N-SBFD symbols in one slot. In this case, the terminal may postpone (or drop) the CG-based PUSCH transmission, the periodic SRS transmission, the semi-persistent SRS transmission, the periodic PUCCH transmission, or the semi-persistent PUCCH transmission.

In a dynamic scheduling scheme based on DCI, the terminal may determine a symbol type for communication based on a type (e.g., SBFD symbol or N-SBFD symbol) of the first symbol indicated by scheduling information (e.g., scheduling DCI) in the time domain. For example, when the scheduling information indicates a resource (e.g., time resource) from a symbol #N to a symbol #M and the symbol #N (e.g., symbol type of the first occasion) is an SBFD symbol, the terminal may perform communication using SBFD symbols. N and M may each be a natural number, and N may be less than M. In another example, when the scheduling information indicates a resource (e.g., time resource) from the symbol #N to the symbol #M and the symbol #N (e.g., symbol type of the first occasion) is an N-SBFD symbol, the terminal may perform communication using N-SBFD symbols. In the present disclosure, an occasion may refer to a PDCCH occasion, a PDSCH occasion, a PUCCH occasion, or a PUSCH occasion. The terminal may not expect the first occasion to be mapped to both SBFD symbols and N-SBFD symbols. In other words, the first occasion may not be mapped to both SBFD symbols and N-SBFD symbols.

In the SPS scheduling scheme or the CG scheduling scheme, a symbol type for communication (e.g., PDSCH reception or PUSCH transmission) may be determined based on RRC configuration. The base station may transmit SPS scheduling information (e.g., SPS configuration information) or CG scheduling information (e.g., CG configuration information) to the terminal through signaling (e.g., RRC configuration). The terminal may receive the SPS scheduling information or CG scheduling information through signaling of the base station. The SPS scheduling information may include information on a symbol type for PDSCH reception. The CG scheduling information may include information on a symbol type for PUSCH transmission. The communication node (e.g., base station and/or terminal) may perform PDSCH reception or PUSCH transmission in symbols (e.g., SBFD symbols or N-SBFD symbols) having the symbol type indicated by the scheduling information.

In another exemplary embodiment, a symbol type for PDSCH reception may be determined based on a symbol type for the first PDSCH reception (e.g., a symbol type of the first PDSCH occasion) after a time when SPS scheduling is activated. A symbol type for PUSCH transmission may be determined based on a symbol type for the first PUSCH transmission (e.g., a symbol type of the first PUSCH occasion) after a time when CG scheduling is activated. For example, when an activation message for SPS scheduling is received in the slot #N and a position of the first PDSCH reception (e.g., the first PDSCH occasion) after reception of the activation message corresponds to an SBFD symbol, the terminal may interpret that the SPS scheduling is scheduling for SBFD symbols and may perform PDSCH reception in SBFD symbols (e.g., SBFD symbols within a plurality of slots). When an activation message for SPS scheduling is received in the slot #N and a position of the first PDSCH reception (e.g., the first PDSCH occasion) after reception of the activation message corresponds to an N-SBFD symbol, the terminal may interpret that the SPS scheduling is scheduling for N-SBFD symbols and may perform PDSCH reception in N-SBFD symbols (e.g., N-SBFD symbols within a plurality of slots). The base station may determine a valid symbol type based on the above-described method and may perform communication based on SPS scheduling in one or more symbols having the valid symbol type.

In another example, when an activation message for CG scheduling is received in the slot #N and a position of the first PUSCH transmission (e.g., the first PUSCH occasion) after reception of the activation message corresponds to an SBFD symbol, the terminal may interpret that the CG scheduling is scheduling for SBFD symbols and may perform PUSCH transmission in SBFD symbols (e.g., SBFD symbols within a plurality of slots). When an activation message for CG scheduling is received in the slot #N and a position of the first PUSCH transmission (e.g., the first PUSCH occasion) after reception of the activation message corresponds to an N-SBFD symbol, the terminal may interpret that the CG scheduling is scheduling for N-SBFD symbols and may perform PUSCH transmission in N-SBFD symbols (e.g., N-SBFD symbols within a plurality of slots). The base station may determine a valid symbol type based on the above-described method and may perform communication based on CG scheduling in one or more symbols having the valid symbol type.

In another exemplary embodiment, the base station may indicate that the terminal is to perform communication across SBFD symbols and N-SBFD symbols in a plurality of slots. The terminal may perform communication in symbols (e.g., SBFD symbols or N-SBFD symbols) having one symbol type in each slot based on the indication of the base station. The terminal may perform communication by using symbols having different symbol types in different slots. For example, the terminal may perform communication by using SBFD symbols in a first slot, and the terminal may perform communication by using N-SBFD symbols in a second slot.

The base station may indicate that the terminal is to perform one exemplary embodiment among the above-described exemplary embodiments (e.g., the above-described methods). The terminal may perform communication across SBFD symbols and N-SBFD symbols within a plurality of slots based on the indication of the base station. The base station may expect to perform communication with the terminal across SBFD symbols and N-SBFD symbols within the plurality of slots based on the indication.

A region included in a downlink BWP among frequency resources of a downlink subband may be DL usable PRBs. The downlink BWP may be an activated downlink BWP. A region included in an uplink BWP among frequency resources of an uplink subband may be UL usable PRBs. The uplink BWP may be an activated uplink BWP. The DL usable PRBs may be defined as an overlapped region between the downlink BWP and the downlink subband of SBFD symbols. The DL usable PRBs may refer to PRBs included in both the downlink BWP and the downlink subband. The number of DL usable PRBs may correspond to the number of PRBs included in the DL usable PRBs. The UL usable PRBs may be defined as an overlapped region between the uplink BWP and the uplink subband of SBFD symbols. The UL usable PRBs may refer to PRBs included in both the uplink BWP and the uplink subband. The number of UL usable PRBs may correspond to the number of PRBs included in the UL usable PRBs. The DL usable PRBs may be configured in SBFD symbols within the downlink BWP based on an indication of the base station. The UL usable PRBs may be configured in SBFD symbols within the uplink BWP based on an indication of the base station.

FIG. 7 is a conceptual diagram illustrating exemplary embodiments of UL usable PRBs in SBFD symbols in a communication network.

Referring to FIG. 7, an uplink BWP may exist in the frequency domain. An uplink subband of SBFD symbols may exist in the frequency domain. An overlapped region between the uplink BWP and the uplink subband may exist in the frequency domain, and the overlapped region may be defined as UL usable PRBs.

Hereinafter, communication methods in SBFD symbols based on a frequency resource allocation method are described. Frequency resources for uplink communication may be allocated to a terminal. Frequency resources for downlink communication may be allocated to the terminal. The frequency resources may be allocated based on two methods. In a frequency resource allocation method 1, a bitmap may be used to allocate the frequency resources. Each bit in the bitmap may indicate whether one or more PRBs are allocated for communication. In a frequency resource allocation method 2, a resource indication value (RIV) may be used to allocate the frequency resources. The RIV may indicate a start position of the frequency resources allocated for communication and a length (e.g., size, bandwidth) of the frequency resources. Communication in SBFD symbols may be performed differently according to a frequency resource allocation method.

When the SBFD transmission/reception configuration 1 is indicated to the terminal and frequency resources are scheduled based on the frequency resource allocation method 1, the terminal may perform communication (e.g., downlink reception or uplink transmission) in SBFD symbols by using DL usable PRBs or UL usable PRBs. The terminal may not perform communication in resources that do not belong to the DL usable PRBs or the UL usable PRBs among the resources indicated by the frequency resource allocation method 1. For example, when an RB group (RBG) including one or more RBs is allocated to the terminal through the frequency resource allocation method 1, and some PRBs within the RBG exist in the DL usable PRBs or the UL usable PRBs, and other PRBs within the RBG do not exist in the DL usable PRBs or the UL usable PRBs, the terminal may use some PRBs existing in the DL usable PRBs for downlink communication, and the terminal may use some PRBs existing in the UL usable PRBs for uplink communication.

The terminal may not use PRBs among PRBs within the allocated RBG, which do not exist in the DL usable PRBs, for downlink communication. The terminal may not use PRBs among PRBs within the allocated RBG, which do not exist in the UL usable PRBs, for uplink communication. The terminal may not use PRBs among PRBs within the allocated RBG, which do not exist in the downlink subbands, for downlink communication. The terminal may not use PRBs among PRBs within the allocated RBG, which do not exist in the uplink subbands, for uplink communication.

In order to determine the number of PRBs for determining a transport block size (TBS) of downlink communication or uplink communication, the terminal may use PRBs belonging to the DL usable PRBs or the UL usable PRBs among the resources indicated by the frequency resource allocation method 1. In order to determine the number of PRBs for determining a TBS of downlink communication or uplink communication, the terminal may determine the number of PRBs for determining the TBS by excluding PRBs that do not belong to the DL usable PRBs or the UL usable PRBs among the resources indicated by the frequency resource allocation method 1. For example, when an RBG including one or more RBs is allocated through the frequency resource allocation method 1, and some PRBs within the RBG belong to the DL usable PRBs or the UL usable PRBs, and other PRBs within the RBG do not belong to the DL usable PRBs or the UL usable PRBs, the terminal may determine the number of PRBs for determining the TBS of downlink communication or uplink communication by using the PRBs belonging to the DL usable PRBs or the UL usable PRBs. The terminal may exclude the PRBs that do not belong to the DL usable PRBs or the UL usable PRBs from determining the number of PRBs for determining the TBS of downlink communication or uplink communication.

When an RBG including one or more RBs is allocated to the terminal, and some PRBs within the RBG exist in a downlink subband or an uplink subband, and other PRBs within the RBG do not exist in the downlink subband or the uplink subband, the terminal may determine the number of PRBs for determining the TBS of downlink communication by using some PRBs among PRBs within the allocated RBG that exist in the downlink subband, and the terminal may determine the number of PRBs for determining the TBS of uplink communication by using some PRBs among PRBs within the allocated RBG that exist in the uplink subband. The terminal may exclude other PRBs among PRBs within the allocated RBG that do not exist in the downlink subband from determining the number of PRBs for determining the TBS of downlink communication. The terminal may exclude other PRBs among PRBs within the allocated RBG that do not exist in the uplink subband from determining the number of PRBs for determining the TBS of uplink communication.

When the SBFD transmission/reception configuration 1 is indicated to the terminal and downlink scheduling is performed based on the frequency resource allocation method 2, the terminal may perform downlink reception in SBFD symbols by using DL usable PRBs. The terminal may not perform downlink reception in resources that do not belong to the DL usable PRBs among the resources indicated by the frequency resource allocation method 2. In order to determine the number of PRBs for determining the TBS of downlink communication, the terminal may use the PRBs belonging to the DL usable PRBs among the resources indicated by the frequency resource allocation method 2. In order to determine the number of PRBs for determining the TBS of downlink communication, the terminal may determine the number of PRBs for determining the TBS of downlink communication by excluding PRBs that do not belong to the DL usable PRBs among the resources indicated by the frequency resource allocation method 2.

The terminal may not perform downlink communication in downlink resources that do not exist in the downlink subband among scheduled downlink resources. In order to determine the number of PRBs for determining the TBS of downlink communication, the terminal may use PRBs (e.g., downlink resources) that exist in the downlink subband among the scheduled downlink resources. In order to determine the number of PRBs for determining the TBS of downlink communication, the terminal may determine the number of PRBs for determining the TBS of downlink communication by excluding PRBs that do not exist in the downlink subband among the downlink resources indicated based on the frequency resource allocation method 2,

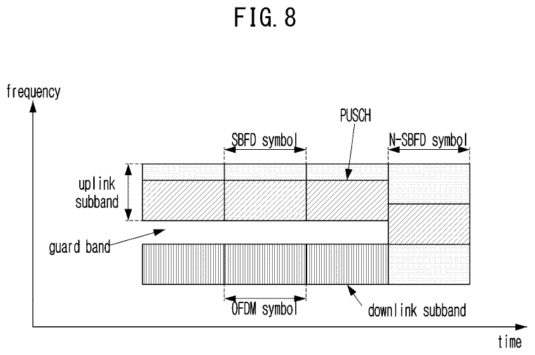

FIG. 8 is a conceptual diagram illustrating exemplary embodiments of a PUSCH scheduling method in a communication network.

Referring to FIG. 8, PUSCH scheduling may be performed across SBFD symbols and N-SBFD symbols. PUSCH scheduling for N-SBFD symbols may be scheduling for PUSCH transmission within an uplink BWP (e.g., activated uplink BWP, UL activated BWP). PUSCH scheduling for SBFD symbols may be scheduling for PUSCH transmission within an uplink subband.

The base station may perform CG-based PUSCH scheduling. In PUSCH transmission by CG-based PUSCH scheduling, the terminal may transmit PUSCH in SBFD symbols or N-SBFD symbols within one slot. When CG-based PUSCH scheduling is applied to one or more slots, the terminal may transmit PUSCH across SBFD symbols and N-SBFD symbols. A frequency region in which PUSCH is transmitted in the SBFD symbols may be different from a frequency region in which PUSCH is transmitted in the N-SBFD symbols.

When the SBFD transmission/reception configuration 1 is indicated to the terminal and CG-based PUSCH scheduling for one or more PUSCH transmissions is indicated to the terminal, the terminal may transmit PUSCH by using SBFD symbols or N-SBFD symbols. The terminal may perform PUSCH transmission by using one symbol type (e.g., SBFD symbol or N-SBFD symbol). The terminal may determine one symbol type for PUSCH transmission and may perform PUSCH transmission by using the determined one symbol type. The terminal may determine as the one symbol type a symbol type (e.g., SBFD symbol or N-SBFD symbol) in which the first PUSCH transmission indicated by the CG-based PUSCH scheduling is performed (e.g., the first PUSCH occasion is configured), and may perform PUSCH transmissions (e.g., all PUSCH transmissions) indicated by the CG-based PUSCH scheduling by using the determined symbol type. For example, based on the first PUSCH transmission (e.g., the first PUSCH occasion) indicated by the CG-based PUSCH scheduling that is configured in SBFD symbols, the terminal may perform PUSCH transmissions indicated by the CG-based PUSCH scheduling in SBFD symbols. Based on the first PUSCH transmission (e.g., the first PUSCH occasion) indicated by the CG-based PUSCH scheduling that is configured in N-SBFD symbols, the terminal may perform PUSCH transmissions indicated by the CG-based PUSCH scheduling in N-SBFD symbols. A PUSCH occasion may refer to a PUSCH transmission occasion.

In another method, the base station may transmit to the terminal information indicating a symbol type for PUSCH transmissions indicated by the CG-based PUSCH scheduling through signaling (e.g., higher layer message, RRC configuration). The terminal may identify the symbol type for PUSCH transmission(s) indicated by the CG-based PUSCH scheduling through signaling of the base station. The terminal may perform PUSCH transmission(s) indicated by the CG-based PUSCH scheduling by using the symbol type indicated by the base station.

The base station may schedule repeated PUSCH transmissions. When scheduling of repeated PUSCH transmissions is indicated to the terminal, the terminal may perform repeated PUSCH transmissions in one or more slots. When scheduling of repeated PUSCH transmissions for one or more slots is indicated to the terminal, the terminal may transmit PUSCH by using SBFD symbols or N-SBFD symbols in each of the one or more slots. A frequency region in which PUSCH is transmitted in SBFD symbols may be different from a frequency region in which PUSCH is transmitted in N-SBFD symbols.

The base station may schedule one or more PUSCH transmissions by using one DCI. The terminal may receive one DCI for scheduling one or more PUSCH transmissions from the base station and may transmit PUSCH in one or more slots based on the one DCI. PUSCH may be transmitted by using the same time resource (e.g., the same OFDM symbols) in each slot. When one DCI schedules one or more PUSCH transmissions, the terminal may transmit PUSCH across SBFD symbols and N-SBFD symbols. A frequency region in which PUSCH is transmitted in SBFD symbols may be different from a frequency region in which PUSCH is transmitted in N-SBFD symbols.

The base station may perform TBoMS-based PUSCH scheduling. When the base station performs TBoMS-based PUSCH scheduling, the terminal may transmit PUSCH in one or more slots. PUSCH may be transmitted by using the same time resource (e.g., the same OFDM symbols) in each slot. When TBoMS-based PUSCH scheduling is indicated to the terminal, the terminal may transmit PUSCH across SBFD symbols and N-SBFD symbols. A frequency region in which PUSCH is transmitted in SBFD symbols may be different from a frequency region in which PUSCH is transmitted in N-SBFD symbols.

The base station may transmit to the terminal time resource configuration information including information indicating a symbol type (e.g., SBFD symbol or N-SBFD symbol) through signaling (e.g., system information, higher layer message, RRC configuration). The terminal may receive the time resource configuration information through signaling of the base station and may identify the symbol type based on the information included in the time resource configuration information. The terminal may perform PUSCH transmission based on the symbol type. In other words, the terminal may determine whether to perform PUSCH transmission based on the symbol type.

The base station may perform independent resource allocation for each of SBFD symbols and N-SBFD symbols. For example, PUSCH scheduling for SBFD symbols and PUSCH scheduling for N-SBFD symbols may be performed independently. For independent PUSCH scheduling for each of SBFD symbols and N-SBFD symbols, different frequency resources (e.g., different frequency regions) may be configured (e.g., allocated, indicated) to the terminal. The terminal may receive independent scheduling information (e.g., PUSCH scheduling information) for each of SBFD symbols and N-SBFD symbols from the base station. Scheduling information for SBFD symbols may be referred to as SBFD scheduling information. Scheduling information for N-SBFD symbols may be referred to as N-SBFD scheduling information. The terminal may determine whether symbols indicated by the scheduling information are SBFD symbols or N-SBFD symbols. Based on the symbols being SBFD symbols, the terminal may perform PUSCH transmission by using the SBFD scheduling information. Based on the symbols being N-SBFD symbols, the terminal may perform PUSCH transmission by using the N-SBFD scheduling information.

In another exemplary embodiment, the base station may transmit N-SBFD scheduling information to the terminal and may transmit a frequency offset (e.g., frequency resource offset) for SBFD symbols to the terminal. Alternatively, the base station may transmit SBFD scheduling information to the terminal and may transmit a frequency offset for N-SBFD symbols to the terminal. The terminal may interpret frequency domain resource allocation (FDRA) information included in the scheduling information based on the frequency offset. For example, the terminal may identify (e.g., determine) a frequency resource in SBFD symbols by applying the frequency offset for SBFD symbols to frequency resources indicated by the FDRA information included in the N-SBFD scheduling information. The terminal may identify (e.g., determine) a frequency resource in N-SBFD symbols by applying the frequency offset for N-SBFD symbols to frequency resources indicated by the FDRA information included in the SBFD scheduling information. The FDRA information may be a bitmap or an RIV indicating frequency resources. The terminal may interpret the FDRA information (e.g., RIV) by using the frequency offset (e.g., frequency offset value). The terminal may interpret the FDRA information (e.g., scheduling information of frequency resources) differently according to a symbol type. The terminal may transmit PUSCH to the base station based on the interpreted information (e.g., frequency resources).

The frequency offset may be indicated to the terminal through a higher layer message (e.g., RRC configuration) or a physical layer message (e.g., DCI) of the base station. The frequency offset may be included in SBFD configuration information transmitted by the base station. The terminal may identify the frequency offset included in the SBFD configuration information received from the base station. The terminal may identify the frequency offset based on information of UL usable PRBs. The terminal may identify the frequency offset based on a frequency difference (e.g., PRB difference) between a start PRB of the activated uplink BWP and a start PRB of the UL usable PRBs. Alternatively, the terminal may identify the frequency offset based on a frequency difference (e.g., PRB difference) between an end PRB of the activated uplink BWP and an end PRB of the UL usable PRBs. The activated uplink BWP may refer to a UL activated BWP.

The terminal may identify frequency resources for PUSCH transmission by using the frequency offset. The base station may identify frequency resources for PUSCH reception by using the frequency offset. A length of PRBs in a frequency region in which PUSCH is scheduled may be expressed as L, a PRB index at a start position of PUSCH transmission in the frequency region may be expressed as S, a size of the activated BWP may be expressed as N, and the frequency offset may be expressed as O. L and N may each be natural numbers, and S and O may each be integers equal to or greater than 0. In the above-described situation, an RIV for SBFD symbols may be indicated (e.g., determined) based on Equation 1 below or Equation 2 below. The communication node (e.g., base station and/or terminal) may determine the RIV for SBFD symbols based on Equation 1 below or Equation 2 below.

$$RIV = N ( L - 1 ) + S - O , If L - 1 \leq ⌊ N / 2 ⌋ \qquad [ Equation 1 ]$$

$$RIV = N ( N - L + 1 ) + ( N - 1 - S - O ) , If L - 1 > ⌊ N / 2 ⌋$$

$$RIV = N ( L - 1 ) + S + O , If L - 1 \leq ⌊ N / 2 ⌋ \qquad [ Equation 2 ]$$

$$RIV = N ( N - L + 1 ) + ( N - 1 - S + O ) , If L - 1 > ⌊ N / 2 ⌋$$

The terminal may receive, from the base station, scheduling information for PUSCH across SBFD symbols and N-SBFD symbols in different slots. In the present disclosure, PUSCH scheduling may be repeated PUSCH transmission scheduling, CG-based PUSCH scheduling, scheduling of one or more PUSCH transmissions using one DCI, and/or TBoMS-based PUSCH scheduling. The terminal may determine a start PRB index of PUSCH transmission in a frequency region of SBFD symbols based on the PUSCH scheduling. The terminal may receive PUSCH transmission resource information for N-SBFD symbols from the base station, and the PUSCH transmission resource information may include an RIV (or a bitmap). The terminal may determine the start PRB index of PUSCH in the frequency region of SBFD symbols by using the PUSCH transmission resource information for N-SBFD symbols, based on a determination method of a start PRB index of PUSCH (e.g., PUSCH transmission) described below. The determination method of a start PRB index of PUSCH may be applied when frequency hopping is not activated. Alternatively, the determination method of a start PRB index of PUSCH may be applied even when frequency hopping is activated. The determination method of a start PRB index of PUSCH may be applied when the SBFD transmission/reception configuration 1 or the SBFD transmission/reception configuration 2 is indicated.

The start PRB index S of PUSCH in the frequency region of SBFD symbols may be determined based on a start index N of PUSCH in a frequency region of N-SBFD symbols and a frequency offset O. For example, the communication node (e.g., base station and/or terminal) may determine the start PRB index S of PUSCH in the frequency region of SBFD symbols based on Equation 3 below. Each of S and N may be an index calculated (e.g., determined) with reference to the start PRB of the uplink BWP. Each of S, N, and O may be an integer equal to or greater than 0.

$$S = N + O \qquad [ Equation 3 ]$$

In another exemplary embodiment, the start PRB index S of PUSCH in the frequency region of SBFD symbols may be determined based on the start index N of PUSCH in the frequency region of N-SBFD symbols, the frequency offset O, and the number W of PRBs included in the BWP. For example, the communication node (e.g., base station and/or terminal) may determine the start PRB index S of PUSCH in the frequency region of SBFD symbols based on Equation 4 below. When the frequency offset O is not separately indicated to the terminal, the frequency offset O may be defined as 0 (zero). Each of S and N may be an index calculated (e.g., determined) with reference to the start PRB of the uplink BWP. mod may denote a modulo operation. Each of S, N, O, and W may be an integer equal to or greater than 0.

$$S = ( N + O ) mod W \qquad [ Equation 4 ]$$

In another exemplary embodiment, the start PRB index S of PUSCH in the frequency region of SBFD symbols may be determined based on an index U of a start PRB of UL usable PRBs, the start index N of PUSCH in the frequency region of N-SBFD symbols, the frequency offset O, and the number A of PRBs included in the UL usable PRBs. The index U of the start PRB of UL usable PRBs may refer to a start PRB index of PRBs (e.g., UL usable PRBs) belonging to both the uplink subband and the UL activated BWP with reference to the start of the UL activated BWP. The start index N of PUSCH in the frequency region of N-SBFD symbols may refer to a start index of an RBG. The RBG may be a frequency resource for PUSCH transmission in N-SBFD symbols. In other words, the RBG may be an RBG for PUSCH transmission occasions in N-SBFD symbols. The RBG (e.g., the RBG for PUSCH transmission occasions in N-SBFD symbols) may be indicated by the FDRA information included in scheduling information. A size of the RBG (e.g., a size of frequency resources) for PUSCH transmission occasions in N-SBFD symbols may be the same as a size of the RBG (e.g., a size of frequency resources) for PUSCH transmission occasions in SBFD symbols. The number A of PRBs included in the UL usable PRBs may be the number of PRBs (e.g., PRBs included in the UL usable PRBs) belonging to both the UL activated BWP and the UL subband.

The communication node (e.g., base station and/or terminal) may determine the start PRB index S of PUSCH in the frequency region of SBFD symbols based on Equation 5 below. When the frequency offset O is not separately indicated to the terminal, the frequency offset O may be defined as 0 (zero). The base station may transmit information of the frequency offset O to the terminal through signaling. The terminal may receive the information of the frequency offset O through signaling of the base station. The frequency offset O may be configured according to a type of CG PUSCH transmission. For example, a first frequency offset O for Type 1 CG PUSCH transmission and a second frequency offset O for Type 2 CG PUSCH transmission may each be configured to the terminal. The first frequency offset O for Type 1 CG PUSCH transmission may be different from the second frequency offset O for Type 2 CG PUSCH transmission.

In Type 1 CG PUSCH transmission, the communication node may determine the start PRB index S of PUSCH in the frequency region of SBFD symbols by applying the first frequency offset O to Equation 5 below. In Type 2 CG PUSCH transmission, the communication node may determine the start PRB index S of PUSCH in the frequency region of SBFD symbols by applying the second frequency offset O to Equation 5 below. Each of S, N, and U may be an index calculated (e.g., determined) with reference to the start PRB of the uplink BWP. Each of S, U, N, O, and A may be an integer equal to or greater than 0.

$$S = U + ( N + O ) mod A \qquad [ Equation 5 ]$$

In another exemplary embodiment, for PUSCH transmission using the RBG-based frequency resource allocation method, the communication node (e.g., base station and/or terminal) may determine the start PRB index S of each RBG in the frequency region of SBFD symbols based on Equation 5. For PUSCH transmission using the RBG-based frequency resource allocation method, U may be an index of the start PRB of UL usable PRBs, N may be a start PRB index of the RBG, O may be the frequency offset, and A may be the number of PRBs included in the UL usable PRBs. When the frequency offset O is not separately indicated to the terminal, the frequency offset O may be defined as 0 (zero). U may be an index calculated (e.g., determined) with reference to the start PRB of the uplink BWP.

In another exemplary embodiment, the start PRB index S of PUSCH in the frequency region of SBFD symbols may be determined based on the start index N of PUSCH in the frequency region of N-SBFD symbols, the frequency offset O, the index U of the start PRB of UL usable PRBs, and the number A of PRBs included in the UL usable PRBs. For example, the communication node (e.g., base station and/or terminal) may determine the start PRB index S of PUSCH in the frequency region of SBFD symbols based on Equation 6 below. When the frequency offset O is not separately indicated to the terminal, the frequency offset O may be defined as 0 (zero). Each of S, N, and U may be an index calculated (e.g., determined) with reference to the start PRB of the uplink BWP. Each of S, U, N, O, and A may be an integer equal to or greater than 0.

$$S = U + ( N - U + O ) mod A \qquad [ Equation 6 ]$$

A position of PUSCH transmission in the frequency domain may vary according to a symbol type and/or a frequency offset. A resource size for PUSCH transmission in the frequency domain may be the same regardless of a symbol type.

In Equations 1 to 6, the frequency offset may be configured differently according to an uplink transmission scheme of the terminal. For example, the frequency offset may be configured differently according to a periodic uplink transmission configured by a higher layer message (e.g., Type 1 CG PUSCH), an uplink transmission configured by a higher layer message and activated by a physical layer message (e.g., DCI) (e.g., Type 2 CG PUSCH), or an uplink transmission dynamically scheduled by a physical layer message (e.g., DCI). For example, the frequency offset for Type 1 CG PUSCH may be included in a higher layer message for configuring the CG PUSCH, and the base station may transmit the higher layer message to the terminal. The frequency offset for Type 1 CG PUSCH may be configured (e.g., indicated) to the terminal by a higher layer message. The frequency offset for Type 2 CG PUSCH or dynamic PUSCH may be included in a higher layer message for configuring PUSCH, and the base station may transmit the higher layer message to the terminal. The frequency offset for Type 2 CG PUSCH or dynamic PUSCH may be configured (e.g., indicated) to the terminal by the higher layer message. The frequency offset for Type 2 CG PUSCH or dynamic PUSCH may be commonly configured for the uplink BWP.

In another exemplary embodiment, a transmission position (e.g., frequency resource) of PUSCH in SBFD symbols may be determined, without an indication for a separate frequency offset, based on at least one of a transmission position of PUSCH in N-SBFD symbols, the number of UL usable PRBs (e.g., the number of PRBs included in the UL usable PRBs), the number of PRBs allocated for PUSCH transmission, or the number of PRBs included in the uplink BWP.

The start PRB index S of PUSCH in the frequency region of SBFD symbols may be determined based on the start index N of PUSCH in the frequency region of N-SBFD symbols, the index U of the start PRB of UL usable PRBs, the number A of PRBs included in the UL usable PRBs, and the number P of PRBs allocated for PUSCH transmission. For example, the communication node (e.g., base station and/or terminal) may determine the start PRB index S of PUSCH in the frequency region of SBFD symbols based on Equation 7 below. Each of S, N, and U may be an index calculated (e.g., determined) with reference to the start PRB of the uplink BWP. Each of S, U, N, A, and P may be an integer equal to or greater than 0.

$$S = U + ( N mod ( A - P ) ) \qquad [ Equation 7 ]$$

In another exemplary embodiment, the start PRB index S of PUSCH in the frequency region of SBFD symbols may be determined based on the start index N of PUSCH in the frequency region of N-SBFD symbols, the start PRB index U of UL usable PRBs, and the number A of PRBs included in the UL usable PRBs. For example, the communication node (e.g., base station and/or terminal) may determine the start PRB index S of PUSCH in the frequency region of SBFD symbols based on Equation 8 below. Each of S, N, and U may be an index calculated (e.g., determined) with reference to the start PRB of the uplink BWP. Each of S, U, N, and A may be an integer equal to or greater than 0.

$$S = U + ( N mod A ) \qquad [ Equation 8 ]$$

In another exemplary embodiment, the terminal may identify frequency resource information included in scheduling information and may determine whether to transmit PUSCH based on the identified frequency resource information. For example, when it is identified based on SBFD scheduling information (e.g., SBFD PUSCH scheduling information) that a frequency resource (e.g., frequency region) of PUSCH exists within UL usable PRBs, the terminal may transmit PUSCH based on the SBFD scheduling information. When it is identified based on SBFD scheduling information (e.g., SBFD PUSCH scheduling information) that a frequency resource of PUSCH does not exist within UL usable PRBs, the terminal may not transmit PUSCH based on the SBFD scheduling information. Even when a part of the scheduled frequency resource of PUSCH exists outside the UL usable PRBs, the terminal may determine that the entire frequency resource of PUSCH does not exist inside the UL usable PRBs. The terminal may separately receive, from the base station, information indicating a symbol type of symbols. The terminal may separately receive, from the base station, information of the UL usable PRBs. For example, the terminal may identify information of the UL usable PRBs by using information on the uplink subband of SBFD symbols or information related to the activated uplink BWP. The terminal may determine whether to transmit PUSCH based on the symbol type and the information of the UL usable PRBs.

In another exemplary embodiment, the terminal may perform PUSCH transmission in PUSCH resources (e.g., PUSCH occasions) that exist within the UL usable PRBs among scheduled PUSCH resources. The terminal may perform rate matching for PUSCH resources that do not exist within the UL usable PRBs among the scheduled PUSCH resources.

In another exemplary embodiment, when repeated PUSCH transmission is scheduled across SBFD symbols and N-SBFD symbols within one slot, the terminal may perform PUSCH transmissions (e.g., repeated PUSCH transmissions) in SBFD symbols and N-SBFD symbols. The repeated PUSCH transmission may be based on PUSCH repetition type B. PUSCH transmissions based on PUSCH repetition type B may be performed across SBFD symbols and N-SBFD symbols within one slot. In other words, PUSCH transmission occasions based on PUSCH repetition type B may be configured across SBFD symbols and N-SBFD symbols within one slot.

For repeated PUSCH transmission, ‘nominal repetitions’ and ‘actual repetitions’ may exist. The nominal repetitions may refer to PUSCH repetitions in PUSCH resources indicated by the base station. The actual repetitions may refer to PUSCH repetitions in PUSCH resource(s) actually capable of PUSCH transmission among the PUSCH resources for the nominal repetitions.

For one slot, one or more nominal repetitions may be indicated. One slot may include SBFD symbols and N-SBFD symbols. When the SBFD transmission/reception configuration 1 is indicated to the terminal, the terminal may transmit an actual PUSCH repetition in one symbol type among SBFD symbol and N-SBFD symbol. For example, the terminal may transmit the actual PUSCH repetition in SBFD symbols and may not transmit the actual PUSCH repetition in N-SBFD symbols. Alternatively, the terminal may transmit an actual PUSCH repetition in N-SBFD symbols and may not transmit the actual PUSCH repetition in SBFD symbols. The terminal may drop the actual PUSCH repetition in a symbol type (e.g., N-SBFD symbol or SBFD symbol) other than the symbol type (e.g., SBFD symbol or N-SBFD symbol) in which the actual PUSCH repetition is transmitted within the slot. The terminal may determine a symbol type in which repeated PUSCH transmission (e.g., all PUSCH repetitions) is performed based on a symbol type in which the first PUSCH repetition is transmitted.

In repeated PUSCH transmission scheduled by using a DCI, the terminal may determine a symbol type for repeated PUSCH transmissions (e.g., all PUSCH repetitions) based on a symbol type in which the first PUSCH transmission (e.g., first actual PUSCH repetition) scheduled by the DCI is performed. The symbol type for all PUSCH repetitions scheduled by the DCI may be the same as the symbol type in which the first PUSCH transmission scheduled by the DCI is performed. In CG-based repeated PUSCH transmission, a DCI may activate the CG-based repeated PUSCH transmission. In this case, the terminal may determine a symbol type for the CG-based repeated PUSCH transmission (e.g., all PUSCH repetitions) based on a symbol type in which the first PUSCH transmission (e.g., the first actual PUSCH repetition) is performed.

For one slot, one or more nominal repetitions may be indicated to the terminal. One slot may include SBFD symbols and N-SBFD symbols. When the SBFD transmission/reception configuration 2 is indicated to the terminal, the terminal may transmit an actual PUSCH repetition in SBFD symbols and N-SBFD symbols. The terminal may transmit the actual PUSCH repetition in SBFD symbols, and the terminal may transmit the actual PUSCH repetition in N-SBFD symbols. One PUSCH transmission (e.g., one PUSCH repetition) among PUSCH repetitions may be performed in SBFD symbols or N-SBFD symbols. One PUSCH transmission (e.g., one PUSCH repetition) among the PUSCH repetitions may not be performed across both SBFD symbols and N-SBFD symbols. Within one slot, an actual PUSCH repetition using SBFD symbols and an actual PUSCH repetition using N-SBFD symbols may be performed.

When, in frequency resources scheduled for repeated PUSCH transmission, a length of PRBs is L, a PRB index at a start position of PUSCH transmission in a frequency region is S, a size of an activated BWP is N, and a frequency offset is 0, an RIV for SBFD symbols may be indicated (e.g., determined) based on Equation 1 or Equation 2.

For repeated PUSCH transmission, the communication node (e.g., base station and/or terminal) may determine the start PRB index of PUSCH in the frequency region of SBFD symbols by using one of Equations 3 to 6. The determination method of the start PRB index of PUSCH may be applied when the actual PUSCH repetition is transmitted in SBFD symbols. When the actual PUSCH repetition is transmitted in N-SBFD symbols, the terminal may determine the start PRB index of PUSCH based on an existing determination method of a start PRB index of PUSCH. The determination method of the start PRB index of PUSCH may be applied when frequency hopping is not activated. Alternatively, the determination method of the start PRB index of PUSCH may be applied even when frequency hopping is activated. The determination method of the start PRB index of PUSCH may be applied when the SBFD transmission/reception configuration 1 or the SBFD transmission/reception configuration 2 is indicated.

Application of frequency hopping for PUSCH transmission may be considered. When frequency hopping is applied in PUSCH transmission, a frequency resource in which PUSCH is transmitted may change over time. A frequency resource pattern for PUSCH transmission (e.g., a pattern of frequency resource positions) may be determined based on a frequency hopping offset.

Frequency resources available for PUSCH transmission in SBFD symbols may be different from frequency resources available for PUSCH transmission in N-SBFD symbols. The base station may indicate, through signaling (e.g., system information, higher layer message, RRC configuration, DCI), an independent frequency hopping offset for each of SBFD symbols and N-SBFD symbols to the terminal. The terminal may receive, through signaling of the base station, a frequency hopping offset for SBFD symbols and/or a frequency hopping offset for N-SBFD symbols. The frequency hopping offset for SBFD symbols may be referred to as an SBFD frequency hopping offset. The frequency hopping offset for N-SBFD symbols may be referred to as an N-SBFD frequency hopping offset. In the present disclosure, a frequency hopping offset may be interpreted, depending on context, as the SBFD frequency hopping offset or the N-SBFD frequency hopping offset.

When PUSCH transmission is indicated by dynamic scheduling (e.g., DCI scheduling) or Type 2 CG scheduling (e.g., Type 2 CG PUSCH scheduling), the terminal may determine a frequency hopping offset for PUSCH transmission based on a type of the first symbol (e.g., SBFD symbol or N-SBFD symbol) indicated by scheduling information (e.g., DCI) in the time domain. For example, when the first symbol indicated by the scheduling information in the time domain is an SBFD symbol, the terminal may perform PUSCH transmission by performing frequency hopping based on the SBFD frequency hopping offset indicated by the base station. In another example, when the first symbol indicated by the scheduling information in the time domain is an N-SBFD symbol, the terminal may perform PUSCH transmission by performing frequency hopping based on the N-SBFD frequency hopping offset indicated by the base station. The frequency hopping offset may be applied within one slot. When a frequency hopping offset for DCI scheduling or Type 2 CG scheduling is not configured, the terminal may perform PUSCH transmission in SBFD symbols indicated by the DCI scheduling or the Type 2 CG scheduling without application of frequency hopping.

When scheduling based on an RRC configuration (e.g., CG-based PUSCH scheduling (e.g., Type 1 CG scheduling)) is indicated to the terminal, a frequency hopping offset used for PUSCH transmission may be determined based on RRC configuration information. When the RRC configuration information indicates that the scheduling is scheduling for SBFD symbols, the terminal may transmit PUSCH by performing frequency hopping based on the SBFD frequency hopping offset. When the RRC configuration information indicates that the scheduling is scheduling for N-SBFD symbols, the terminal may transmit PUSCH by applying frequency hopping based on the N-SBFD frequency hopping offset. The frequency hopping offset may be applied within one slot. When an SBFD hopping offset for Type 1 CG PUSCH scheduling is not configured to the terminal, the terminal may perform PUSCH transmission in SBFD symbols indicated by the Type 1 CG PUSCH scheduling without application of frequency hopping.

When an SBFD frequency hopping configuration (e.g., SBFD frequency hopping offset) and/or an N-SBFD frequency hopping configuration (e.g., N-SBFD frequency hopping offset) is indicated to the terminal, the terminal may transmit PUSCH by performing frequency hopping based on the SBFD frequency hopping configuration or the N-SBFD frequency hopping configuration. When an N-SBFD frequency hopping configuration (e.g., N-SBFD frequency hopping offset) is indicated to the terminal and an SBFD frequency hopping configuration (e.g., SBFD frequency hopping offset) is not indicated to the terminal, the terminal may transmit PUSCH by applying frequency hopping in N-SBFD symbols, and the terminal may transmit PUSCH without application of frequency hopping in SBFD symbols.

In PUSCH transmission based on frequency hopping, an intra-slot frequency hopping scheme and/or an inter-slot frequency hopping scheme may be considered. In the intra-slot frequency hopping scheme, the terminal may transmit PUSCH by using two different frequency resources within one slot. In the inter-slot frequency hopping scheme, the terminal may transmit PUSCH by using one frequency resource in one slot and may transmit PUSCH by using another frequency resource in another slot.

In PUSCH transmission using intra-slot frequency hopping, the communication node (e.g., base station and/or terminal) may determine, based on Equation 9, a start PRB index S of the first PUSCH transmission (e.g., first hop) using the intra-slot frequency hopping. K may be the first PRB index of PUSCH transmission indicated by scheduling information (e.g., FDRA, RIV, bitmap). K may be a PRB index of the first hop of the PUSCH transmission. When the SBFD transmission/reception configuration 2 is indicated to the terminal, K may be a PRB index to which an RB offset between SBFD symbols and N-SBFD symbols is applied. Each of S and K may be an integer equal to or greater than 0.

$$S = K \qquad [ Equation 9 ]$$

In PUSCH transmission using intra-slot frequency hopping, the communication node (e.g., base station and/or terminal) may determine, based on Equation 10 below, a start PRB index S of the second PUSCH transmission (e.g., second hop) using the intra-slot frequency hopping. O may be the frequency hopping offset. L may be the number of PRBs included in UL usable PRBs. K may be the PRB index of the first hop of the PUSCH transmission. When the SBFD transmission/reception configuration 2 is indicated to the terminal, K may be the PRB index to which the RB offset between SBFD symbols and N-SBFD symbols is applied. Each of S, K, O, and L may be an integer equal to or greater than 0.

$$S = ( K + O ) mod L \qquad [ Equation 10 ]$$

In PUSCH transmission using intra-slot frequency hopping, the communication node (e.g., base station and/or terminal) may determine, based on Equation 11 below, the start PRB index S of the second PUSCH transmission (e.g., second hop) using the intra-slot frequency hopping. U may be an index of a start PRB of UL usable PRBs. O may be the frequency hopping offset. L may be the number of PRBs included in the UL usable PRBs. Each of S, K, and U may be an index calculated (e.g., determined) with reference to a start PRB of an uplink BWP. K may be the PRB index of the first hop of the PUSCH transmission. When the SBFD transmission and reception configuration 2 is indicated to the terminal, K may be a PRB index to which an RB offset between SBFD symbols and N-SBFD symbols is applied. Each of S, U, K, O, and L may be an integer equal to or greater than 0.

$$S = U + ( K + O ) mod L \qquad [ Equation 11 ]$$

In another exemplary embodiment, in PUSCH transmission using intra-slot frequency hopping, the communication node (e.g., base station and/or terminal) may determine, based on Equation 12 below, the start PRB index S of the second PUSCH transmission (e.g., second hop) using the intra-slot frequency hopping. U may be the index of the start PRB of the UL usable PRBs. In other words, U may be a start PRB index of PRBs (e.g., UL usable PRBs) belonging to both the uplink subband and the UL activated BWP with reference to the start of the UL activated BWP. K may be the PRB index of the first hop of the PUSCH transmission. In other words, K may be the start PRB index of the first PUSCH hop with reference to the start of the UL activated BWP.

O may be the frequency hopping offset. In other words, O may be a frequency hopping offset for a PUSCH transmission opportunity in SBFD symbols. The frequency hopping offset may be an SBFD frequency hopping offset for PUSCH transmission. The base station may transmit the frequency hopping offset to the terminal through signaling. The terminal may receive the frequency hopping offset through signaling of the base station. The frequency hopping offset may be configured for the SBFD transmission/reception configuration 1 or the SBFD transmission/reception configuration 2. L may be the number of PRBs included in the UL usable PRBs. Each of S, K, and U may be an index calculated (e.g., determined) with reference to the start PRB of the uplink BWP. K may be the PRB index of the first hop of the PUSCH transmission. When the SBFD transmission/reception configuration 2 is indicated to the terminal, K may be the PRB index to which the RB offset (e.g., frequency offset) between SBFD symbols and N-SBFD symbols is applied. In other words, K may be a PRB index after the frequency offset from the start of the UL activated BWP. Each of S, U, K, O, and L may be an integer equal to or greater than 0.

$$S = U + ( K - U + O ) mod L \qquad [ Equation 12 ]$$

In PUSCH transmission using inter-slot frequency hopping, the communication node (e.g., base station and/or terminal) may determine a start PRB index S of PUSCH transmission in a slot having an even-numbered slot index based on Equation 9. In PUSCH transmission using inter-slot frequency hopping, the communication node (e.g., base station and/or terminal) may determine a start PRB index S of PUSCH transmission in a slot having an odd-numbered slot index based on Equation 12.

In PUSCH transmission using inter-slot frequency hopping, a start PRB index S(Y) may be determined based on a slot index Y. For example, the communication node (e.g., base station and/or terminal) may determine the start PRB index S(Y) based on Equation 13 below. Each of S, Y, K, U, O, and L may be an integer equal to or greater than 0.

$$\begin{matrix}S ( Y ) = K , & if Y mod 2 = 0 \\ S ( Y ) = U + ( K - U + O ) mod L , & if Y mod 2 = 1\end{matrix} \qquad [ Equation 13 ]$$

U may be an index of a start PRB of UL usable PRBs. O may be a frequency hopping offset. The frequency hopping offset may be an SBFD frequency hopping offset for PUSCH transmission. L may be the number of PRBs included in UL usable PRBs. K may be a PRB index of the first hop of the PUSCH transmission. Each of S, K, and U may be an index calculated (e.g., determined) with reference to a start PRB of an uplink BWP. When the SBFD transmission/reception configuration 2 is indicated to the terminal, K may be a PRB index to which an RB offset between SBFD symbols and N-SBFD symbols is applied.

DMRS bundling for PUSCH transmission may be supported. The base station may transmit, through signaling (e.g., higher layer message, RRC configuration), information indicating whether DMRS bundling is performed to the terminal. The terminal may receive, through signaling of the base station, information indicating whether DMRS bundling is performed. When DMRS bundling is indicated to the terminal, inter-slot frequency hopping for PUSCH transmission of the terminal may differ. The terminal may perform PUSCH transmission by using the same start PRB in slots in which DMRS bundling is indicated. When DMRS bundling is indicated to the terminal, the terminal may perform frequency hopping in units of slots to which DMRS bundling is applied. For example, in PUSCH transmission using inter-slot frequency hopping to which DMRS bundling is applied, the communication node (e.g., base station and/or terminal) may determine the start PRB index S(Y) based on the slot index Y based on Equation 14 below. Each of S, Y, K, F, U, O, and L may be an integer.

$$\begin{matrix}S ( Y ) = K , & if ⌊ \frac{Y}{F} ⌋ mod 2 = 0 \\ S ( Y ) = U + ( K - U + O ) mod L , & if ⌊ \frac{Y}{F} ⌋ mod 2 = 1\end{matrix} \qquad [ Equation 14 ]$$

U may be the index of the start PRB of UL usable PRBs. O may be the frequency hopping offset. The frequency hopping offset may be an SBFD frequency hopping offset for PUSCH transmission. L may be the number of PRBs included in the UL usable PRBs. K may be the PRB index of the first hop of the PUSCH transmission. Each of S, K, and U may be an index calculated with reference to the start PRB of the uplink BWP. When the SBFD transmission/reception configuration 2 is indicated to the terminal, K may be a PRB index to which the RB offset between SBFD symbols and N-SBFD symbols is applied. F may be a frequency hopping interval. The base station may indicate F to the terminal through signaling (e.g., higher layer message). F may be a value configured for PUSCH transmission.

In repeated PUSCH transmission based on PUSCH repetition type B, frequency hopping may be used for each PUSCH repetition. When frequency hopping is used in repeated PUSCH transmission based on PUSCH repetition type B, a start PRB index for an n-th PUSCH repetition may be determined based on a symbol type (e.g., SBFD symbol or N-SBFD symbol) in which the n-th actual PUSCH repetition is transmitted. For example, when frequency hopping is applied in repeated PUSCH transmission based on PUSCH repetition type B and the n-th actual PUSCH repetition is transmitted in SBFD symbols, the communication node (e.g., base station and/or terminal) may determine a start PRB index S based on Equation 15 below. Each of S, K, n, U, O, and L may be an integer.

$$\begin{matrix}S = K , & if n mod 2 = 0 \\ S = U + ( K - U + O ) mod L , & if n mod 2 = 1\end{matrix} \qquad [ Equation 15 ]$$

U may be the index of the start PRB of UL usable PRBs. O may be the frequency hopping offset. The frequency hopping offset may be an SBFD frequency hopping offset for PUSCH transmission. L may be the number of PRBs included in the UL usable PRBs. K may be the PRB index of the first hop of the PUSCH transmission. Each of S, K, and U may be an index calculated (e.g., determined) with reference to the start PRB of the uplink BWP. When the SBFD transmission/reception configuration 2 is indicated to the terminal, K may be the PRB index to which the RB offset between SBFD symbols and N-SBFD symbols is applied.

For example, when frequency hopping is applied in repeated PUSCH transmission based on PUSCH repetition type B and the n-th actual PUSCH repetition is transmitted in N-SBFD symbols, the communication node (e.g., base station and/or terminal) may determine the start PRB index S based on Equation 16 below. Each of S, K, n, O, and H may be an integer.

$$\begin{matrix}S = K , & if n mod 2 = 0 \\ S = ( K + O ) mod H , & if n mod 2 = 1\end{matrix} \qquad [ Equation 16 ]$$

O may be the frequency hopping offset. The frequency hopping offset may be an N-SBFD frequency hopping offset for PUSCH transmission. H may be the number of PRBs included in the uplink BWP. K may be the PRB index of the first hop of the PUSCH transmission. Alternatively, K may be the index of the start PRB of the uplink BWP. Each of S and K may be an index calculated (e.g., determined) with reference to the start PRB of the uplink BWP.

In a communication system, a terminal may perform PUCCH transmission. The terminal may perform PUCCH transmission by using two different frequency resources within a slot. For example, the terminal may perform PUCCH transmission by using a frequency resource #1 in some symbols in the slot and may perform PUCCH transmission by using a frequency resource #2 in other symbols in the slot. The terminal may perform frequency hopping for PUCCH transmission based on the above-described method. A base station may transmit, through signaling (e.g., higher layer message, RRC configuration), frequency resource information for PUCCH transmission (e.g., information of the frequency resource #1 and the frequency resource #2) to the terminal. The terminal may receive the frequency resource information for PUCCH transmission through signaling of the base station.

Frequency resources available for PUCCH transmission in SBFD symbols may be different from frequency resources available for PUCCH transmission in N-SBFD symbols. The base station may transmit, through signaling (e.g., higher layer message, RRC configuration), independent frequency resource information for PUCCH transmission for each of SBFD symbols and N-SBFD symbols to the terminal. The terminal may receive, through signaling of the base station, SBFD frequency resource information for PUCCH transmission and N-SBFD frequency resource information for PUCCH transmission. For example, the base station may transmit to the terminal information of a frequency resource #1-1 for PUCCH transmission in SBFD symbols. The base station may transmit to the terminal information of a frequency resource #2-1 for PUCCH transmission based on frequency hopping in SBFD symbols. The base station may transmit to the terminal information of a frequency resource #1-2 for PUCCH transmission in N-SBFD symbols. The base station may transmit to the terminal information of a frequency resource #2-2 for PUCCH transmission based on frequency hopping in N-SBFD symbols.

The terminal may perform PUCCH transmission by using different frequency resources based on a symbol type in which PUCCH transmission is performed. The terminal may perform PUCCH transmission by using different frequency hopping configurations (e.g., frequency hopping scheme, frequency hopping offset) based on a symbol type in which PUCCH transmission is performed.

The base station may transmit, through signaling (e.g., higher layer message, RRC configuration), information indicating activation or deactivation of frequency hopping for PUCCH transmission to the terminal. The terminal may receive, through signaling of the base station, the information indicating activation or deactivation of frequency hopping for PUCCH transmission. The terminal may determine whether to apply frequency hopping for PUCCH transmission based on the information received from the base station. The base station may transmit, through signaling, information indicating whether common frequency hopping for PUCCH transmission is applied in SBFD symbols and N-SBFD symbols to the terminal. The terminal may receive, through signaling of the base station, the information indicating whether common frequency hopping for PUCCH transmission is applied in SBFD symbols and N-SBFD symbols. For example, the base station may indicate activation of frequency hopping for PUCCH transmission in SBFD symbols and N-SBFD symbols to the terminal. Alternatively, the base station may indicate deactivation of frequency hopping for PUCCH transmission in SBFD symbols and N-SBFD symbols to the terminal. The terminal may perform PUCCH transmission by applying frequency hopping (e.g., common frequency hopping) in SBFD symbols and N-SBFD symbols. The terminal may perform PUCCH transmission without applying frequency hopping (e.g., common frequency hopping) in SBFD symbols and N-SBFD symbols.

When a frequency resource for PUCCH transmission in SBFD symbols or N-SBFD symbols is configured for the terminal, the terminal may perform PUCCH transmission using configuration information of the frequency resource. When a frequency resource for PUCCH transmission in N-SBFD symbols is configured for the terminal and a frequency resource for PUCCH transmission in SBFD symbols is not configured for the terminal, the terminal may perform PUCCH transmission in N-SBFD symbols and may not perform PUCCH transmission in SBFD symbols. Alternatively, when a frequency resource for PUCCH transmission in N-SBFD symbols is configured for the terminal and a frequency resource for PUCCH transmission in SBFD symbols is not configured for the terminal, the terminal may perform PUCCH transmission in SBFD symbols using the frequency resource configured for PUCCH transmission in N-SBFD symbols. A frequency resource for PUCCH transmission in N-SBFD symbols and a frequency resource for PUCCH transmission in SBFD symbols may have the same PUCCH resource ID.

The terminal may transmit a CSI report to the base station using a periodic CSI-RS resource or a semi-persistent CSI-RS resource. The base station may indicate, through signaling, CSI-RS resources used for CSI calculation (e.g., CSI determination, CSI generation) to the terminal. The terminal may identify the CSI-RS resources indicated by signaling of the base station. The base station may instruct the terminal to perform CSI calculation using CSI-RS resources belonging to one symbol type among SBFD symbol or N-SBFD symbol. The above indication may be transmitted to the terminal through signaling (e.g., higher layer message, RRC configuration) of the base station. The above indication may be included in a CSI report configuration, and the base station may transmit the CSI report configuration to the terminal. The terminal may perform CSI calculation using CSI-RS resources belonging to SBFD symbols or N-SBFD symbols based on the indication of the base station and may transmit a CSI report to the base station. The terminal may not use CSI-RS resources belonging to a symbol type not indicated by the base station for CSI calculation. For example, when the base station instructs the terminal to perform CSI calculation using CSI-RS resources belonging to SBFD symbols, the terminal may perform CSI calculation using the CSI-RS resources belonging to SBFD symbols, and the terminal may not use CSI-RS resources belonging to N-SBFD symbols for CSI calculation.

The terminal may perform semi-persistent CSI reporting. The base station may receive semi-persistent CSI reports from the terminal. The base station may transmit an activation message for semi-persistent CSI reporting to the terminal. The activation message may request CSI reporting. The activation message for CSI reporting (e.g., CSI request) may be included in a DCI, and the base station may transmit the DCI to the terminal. The terminal may receive the activation message from the base station and may perform semi-persistent CSI reporting based on the activation message. The terminal may perform CSI reporting after a time offset from a reception time of the DCI. The base station may transmit, through signaling, the time offset for CSI reporting to the terminal. The terminal may receive, through signaling of the base station, the time offset for CSI reporting. The terminal may perform CSI reporting according to a time period after the time offset from the reception time of the DCI. The base station may transmit, through signaling, the time period for CSI reporting to the terminal. The terminal may receive, through signaling of the base station, the time period for CSI reporting. The terminal may perform periodic CSI reporting according to the time period after the time offset from the reception time of DCI activating (e.g., requesting) CSI reporting.

The terminal may transmit the CSI report to the base station on a PUSCH or PUCCH. When the SBFD transmission/reception configuration 1 is indicated to the terminal and the semi-persistent CSI report is transmitted on a PUSCH, the terminal may periodically transmit the semi-persistent CSI report to the base station using SBFD symbols or N-SBFD symbols in a slot. The terminal may determine resources (e.g., symbol type) for performing periodic CSI reporting based on a symbol type of the first PUSCH resource determined based on the reception time of the DCI activating CSI reporting and the time offset. For example, when the first PUSCH resource determined based on the reception time of the DCI activating CSI reporting and the time offset is SBFD symbols (e.g., when signal transmission in the slot is performed in SBFD symbols), the terminal may periodically perform CSI reporting (e.g., semi-persistent CSI reporting) using SBFD symbols. When the first PUSCH resource determined based on the reception time of the DCI activating CSI reporting and the time offset is N-SBFD symbols (e.g., when signal transmission in the slot is performed in N-SBFD symbols), the terminal may periodically perform CSI reporting (e.g., semi-persistent CSI reporting) using N-SBFD symbols.

When the SBFD transmission/reception configuration 1 is indicated to the terminal and the semi-persistent CSI report is transmitted on a PUCCH, the terminal may periodically transmit the semi-persistent CSI report using SBFD symbols or N-SBFD symbols in a slot. The base station may transmit, through signaling (e.g., higher layer signaling, RRC configuration), information on a symbol type used for semi-persistent CSI reporting to the terminal. The terminal may receive, through signaling of the base station, information on a symbol type used for semi-persistent CSI reporting.

The terminal may transmit sounding reference signal (SRS). The terminal may transmit SRS in SBFD symbols or N-SBFD symbols. The base station may transmit, through signaling, a configuration (e.g., RRC configuration) of SRS transmission in SBFD symbols and/or a configuration (e.g., RRC configuration) of SRS transmission in N-SBFD symbols to the terminal. Configuration of SRS transmission in SBFD symbols may be referred to as an SBFD SRS configuration. Configuration of SRS transmission in N-SBFD symbols may be referred to as an N-SBFD SRS configuration. The terminal may receive, through signaling of the base station, the SBFD SRS configuration (e.g., SBFD SRS configuration information) and/or the N-SBFD SRS configuration (e.g., N-SBFD SRS configuration information). The SBFD SRS configuration and the N-SBFD SRS configuration may be indicated (e.g., configured) independently. For the same usage of SRS transmission configuration, the SBFD SRS configuration and the N-SBFD SRS configuration may include the same number of SRS resources. The usage of SRS transmission configuration may be codebook-based SRS or non-codebook-based SRS.

The terminal may receive the SBFD SRS configuration (e.g., SBFD SRS indication) from the base station. The terminal may transmit SRS in SBFD symbols based on the SBFD SRS configuration. The base station may transmit, through signaling, a configuration (e.g., indication) for periodic SRS transmission or semi-persistent SRS transmission to the terminal. The terminal may receive, through signaling of the base station, the configuration (e.g., indication) for periodic SRS transmission or semi-persistent SRS transmission. The terminal may perform periodic SRS transmission or semi-persistent SRS transmission based on the configuration (e.g., indication) of the base station. When the symbol type in which SRS transmission (e.g., periodic SRS transmission or semi-persistent SRS transmission) is performed indicates SBFD symbol, the terminal may perform SRS transmission in SBFD symbols. When the symbol type in which SRS transmission (e.g., periodic SRS transmission or semi-persistent SRS transmission) is performed indicates N-SBFD symbol, the terminal may perform SRS transmission in N-SBFD symbols.

The terminal may perform aperiodic SRS transmission in SBFD symbols based on a configuration (e.g., indication) of the base station. The base station may transmit, through signaling, the configuration (e.g., indication) of aperiodic SRS transmission based on slot counting to the terminal. The terminal may receive, through signaling of the base station, the configuration (e.g., indication) of aperiodic SRS transmission based on slot counting. The terminal may consider SBFD symbols (e.g., a slot composed of SBFD symbols) as a symbol type (e.g., slot) for aperiodic SRS transmission based on slot counting. The terminal may not consider N-SBFD symbols in slot counting for aperiodic SRS transmission. The base station may indicate aperiodic SRS transmission to the terminal. The terminal may receive the indication of aperiodic SRS transmission from the base station. The terminal may expect not to receive an indication of SRS transmission in N-SBFD symbols.

The terminal may transmit SRS in N-SBFD symbols based on a configuration (e.g., indication) of the base station. The base station may transmit, through signaling, the configuration (e.g., indication) of periodic SRS transmission or semi-persistent SRS transmission to the terminal. The terminal may receive, through signaling of the base station, the configuration (e.g., indication) of periodic SRS transmission or semi-persistent SRS transmission. The terminal may perform periodic SRS transmission based on the configuration of periodic SRS transmission. The terminal may perform semi-persistent SRS transmission based on the configuration of semi-persistent SRS transmission. When the symbol type in which SRS transmission (e.g., periodic SRS transmission or semi-persistent SRS transmission) is performed indicates N-SBFD symbol, the terminal may perform SRS transmission in N-SBFD symbols. When the symbol type in which SRS transmission (e.g., periodic SRS transmission or semi-persistent SRS transmission) is performed indicates SBFD symbol, the terminal may not perform SRS transmission in N-SBFD symbols.

The terminal may perform aperiodic SRS transmission in N-SBFD symbols based on a configuration (e.g., indication) of the base station. The base station may transmit, through signaling, the configuration (e.g., indication) of aperiodic SRS transmission based on slot counting to the terminal. The terminal may receive, through signaling of the base station, the configuration (e.g., indication) of aperiodic SRS transmission based on slot counting. The terminal may consider N-SBFD symbol (e.g., slot composed of N-SBFD symbols) as a symbol type (e.g., slot) for aperiodic SRS transmission based on slot counting. The terminal may not consider SBFD symbols in slot counting for aperiodic SRS transmission. The base station may indicate aperiodic SRS transmission to the terminal. The terminal may receive the indication of aperiodic SRS transmission from the base station. The terminal may expect not to receive an indication for SRS transmission in SBFD symbols.

A definition of available slots used for slot counting in aperiodic SRS transmission based on slot counting may vary according to an SBFD SRS configuration or an N-SBFD SRS configuration.

Available slots for aperiodic SRS transmission based on slot counting may be defined in SBFD symbols. When availableSlotOffsetList is configured for the terminal through a higher layer message, an available slot may indicate a slot in which SBFD symbols include all time resources of the SRS resource. All time resources of SRS resources may refer to time resources for all SRS resources of an SRS resource set. The available slot may satisfy a minimum time requirement between a DCI triggering SRS transmission and all SRS resources of the SRS resource set. The terminal may transmit UE capability information including the minimum time requirement to the base station. The base station may receive the UE capability information from the terminal and may identify the minimum time requirement included in the UE capability information.

Available slots for aperiodic SRS transmission based on slot counting may be defined in N-SBFD symbols. When availableSlotOffsetList is configured for the terminal through a higher layer message, an available slot may indicate a slot in which flexible symbols, that are not configured as uplink symbols or SBFD symbols, include all time resources of SRS resources. All time resources of SRS resources may refer to time resources for all SRS resources of an SRS resource set. The available slot may satisfy a minimum time requirement between a DCI triggering SRS transmission and all SRS resources of the SRS resource set. The terminal may transmit UE capability information including the minimum time requirement to the base station. The base station may receive the UE capability information from the terminal and may identify the minimum time requirement included in the UE capability information.

The base station may indicate repeated PUSCH transmission to the terminal. The terminal may receive the indication of repeated PUSCH transmission from the base station. The terminal may determine availability for each slot for repeated PUSCH transmission.

The SBFD transmission/reception configuration 1 may be configured for the terminal. Configuration of the SBFD transmission/reception configuration 1 for the terminal may mean that the SBFD transmission/reception configuration 2 is not configured for the terminal. The terminal may receive scheduling information of repeated PUCCH transmission or repeated PUSCH transmission (e.g., PUSCH repetition type A) through a DCI. The base station may configure, through signaling, available slot counting (e.g., AvailableSlotCounting) for the terminal. Configuration of available slot counting may refer to activation of available slot counting. When available slot counting is activated, the terminal may perform repeated PUCCH transmission or repeated PUSCH transmission based on a number of available slots. The terminal may receive, from the base station, a configuration of repeated PUCCH transmission or repeated PUSCH transmission exceeding one time. A repletion factor K may exceed 1. The terminal may receive an indication of TBoMS from the base station. The terminal may identify information on a valid symbol type for repeated PUCCH transmission or repeated PUSCH transmission. The terminal may determine whether to perform slot counting based on whether a transmission occasion in each slot is configured in a valid symbol type. When a transmission occasion in a slot is configured in a valid symbol type, the terminal may count the slot in which the transmission occasion is configured as an available slot. When a transmission occasion in a slot is configured in an invalid symbol type, the terminal may not count the slot in which the transmission occasion is configured as an available slot.

A valid symbol type for repeated PUCCH transmission or repeated PUSCH transmission may be determined as SBFD symbol. In this case, when a transmission occasion allocated for PUCCH transmission (e.g., repeated PUCCH transmission) or PUSCH transmission (e.g., repeated PUSCH transmission) is configured in SBFD symbols of one slot and resource(s) allocated for repeated PUCCH transmission and/or repeated PUSCH transmission do not overlap SS/PBCH block transmission resources, the terminal may determine the slot as an available slot. The SS/PBCH block may include a primary synchronization signal (PSS), a secondary synchronization signal (SSS), and a physical broadcast channel (PBCH). The terminal may receive transmission position information of SS/PBCH block from the base station. A transmission position of SS/PBCH block may refer to a time at which SS/PBCH block is transmitted. Allocation of a PUCCH transmission resource or a PUSCH transmission resource in SBFD symbols of one slot may mean that a time resource for one PUCCH transmission or one PUSCH transmission is allocated in SBFD symbols.

A valid symbol type for PUCCH transmission or PUSCH transmission may be determined as N-SBFD symbol. In this case, when a transmission occasion allocated for PUCCH transmission or PUSCH transmission is configured in N-SBFD symbols of one slot, a resource allocated for PUCCH transmission or PUSCH transmission does not overlap SS/PBCH block transmission resources, and the allocated resource is not indicated as downlink symbols by a TDD configuration, the terminal may determine the slot as an available slot. The TDD configuration may be information indicated by the base station. The TDD configuration may include a cell-common TDD configuration and/or a UE-dedicated TDD configuration. That the allocated resource is not indicated as downlink symbols by the TDD configuration may mean that the allocated resource is not indicated as downlink symbols by the cell-common TDD configuration and/or the UE-dedicated TDD configuration. When the UE-dedicated TDD configuration is not indicated to the terminal, that the allocated resource is not indicated as downlink symbols by the TDD configuration may mean that the allocated resource is not indicated as downlink symbols by the cell-common TDD configuration. Allocation of a PUCCH transmission resource or a PUSCH transmission resource in N-SBFD symbols of one slot may mean that a time resource for one PUCCH transmission or one PUSCH transmission is allocated in N-SBFD symbols.

The SBFD transmission/reception configuration 2 may be configured for the terminal. When a transmission occasion allocated for PUCCH transmission or PUSCH transmission is configured in SBFD symbols of one slot and a resource allocated for PUCCH transmission or PUSCH transmission does not overlap SS/PBCH block transmission resources, the terminal may determine the slot as an available slot. That a transmission occasion allocated for PUCCH transmission or PUSCH transmission of one slot is SBFD symbols may mean that a time resource for one PUCCH transmission or PUSCH transmission is allocated in SBFD symbols.

The SBFD transmission/reception configuration 2 may be configured for the terminal. When a transmission occasion allocated for PUCCH transmission or PUSCH transmission is configured in N-SBFD symbols of one slot, a resource allocated for PUCCH transmission or PUSCH transmission does not overlap SS/PBCH block transmission resources, and the allocated resource is not indicated as downlink symbols by a TDD configuration, the terminal may determine the slot as an available slot. The TDD configuration may be information indicated by the base station. The TDD configuration may include a cell-common TDD configuration and/or a UE-dedicated TDD configuration. That the allocated resource is not indicated as downlink symbols by the TDD configuration may mean that the allocated resource is not indicated as downlink symbols by the cell-common TDD configuration and/or the UE-dedicated TDD configuration. When the UE-dedicated TDD configuration is not indicated to the terminal, that the allocated resource is not indicated as downlink symbols by the TDD configuration may mean that the allocated resource is not indicated as downlink symbols by the cell-common TDD configuration. That a transmission occasion allocated for PUCCH transmission or PUSCH transmission of one slot is N-SBFD symbols may mean that a time resource for one PUCCH transmission or one PUSCH transmission is allocated in N-SBFD symbols.

When the slot is determined as an available slot, the terminal may perform PUCCH transmission or PUSCH transmission in the slot. When the slot is determined as unavailable, the terminal may not perform PUCCH transmission or PUSCH transmission in the slot. In this case, the terminal may drop or postpone PUSCH transmission (or PUCCH transmission). The terminal may attempt (e.g., perform) PUCCH transmission or PUSCH transmission until a number of available slots satisfies a preset repetition factor.

The base station or the terminal may transmit and receive DMRS. The base station may transmit DMRS for downlink transmission, and the terminal may receive DMRS from the base station. The terminal may transmit DMRS for uplink transmission, and the base station may receive DMRS from the terminal. DMRS may be transmitted or received in SBFD symbols. A DMRS configuration for SBFD symbols may be the same as a DMRS configuration for N-SBFD symbols. For example, a sequence for DMRS configuration in SBFD symbols may be the same as a sequence for DMRS configuration in N-SBFD symbols. DMRS transmission in SBFD symbols may be performed within DL usable PRBs or UL usable PRBs. DMRS may not be transmitted outside DL usable PRBs or UL usable PRBs. DMRS not present within DL usable PRBs or UL usable PRBs may be punctured. The base station may transmit DMRS within DL usable PRBs, and the terminal may receive DMRS from the base station. The terminal may transmit DMRS within UL usable PRBs, and the base station may receive DMRS from the terminal.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, scheduling information for a plurality of physical uplink shared channel (PUSCH) transmissions across subband full-duplex (SBFD) symbols and non-SBFD (N-SBFD) symbols;
determining, based on the scheduling information, a first start physical resource block (PRB) for one or more PUSCH transmissions among the plurality of PUSCH transmissions in the SBFD symbols; and
transmitting the one or more PUSCH transmissions to the base station using a first frequency resource based on the first start PRB in the SBFD symbols.

2. The method of claim 1, wherein the SBFD symbols and the N-SBFD symbols are located in different slots.

3. The method of claim 1, wherein the SBFD symbols and the N-SBFD symbols are located in a same slot, and the plurality of PUSCH transmissions are based on PUSCH repetition type B.

4. The method of claim 1, further comprising:
determining, based on the scheduling information, a second frequency resource for at least one PUSCH transmission among the plurality of PUSCH transmissions in the N-SBFD symbols; and
transmitting the at least one PUSCH transmission to the base station using the second frequency resource of the N-SBFD symbols.

5. The method of claim 4, wherein a size of the first frequency resource is same as a size of the second frequency resource, and the first start PRB of the first frequency resource is different from a second start PRB of the second frequency resource.

6. The method of claim 4, wherein the scheduling information includes a bitmap indicating the second frequency resource for the at least one PUSCH transmission in the N-SBFD symbols.

7. The method of claim 4, wherein the first start PRB is determined based on S=U+(N+O) mod A, S denotes an index of the first start PRB, U denotes an index of a start PRB of uplink (UL) usable PRBs, N denotes an index of a second start PRB of the second frequency resource in the N-SBFD symbols, O denotes a frequency offset, and A denotes a number of PRBs included in the UL usable PRBs.

8. The method of claim 7, wherein the frequency offset is independently configured for the terminal according to a type of a configured grant (CG) PUSCH transmission.

9. The method of claim 1, wherein the determining of the first start PRB comprises: determining the first start PRB in a first hop or the first start PRB in a second hop based on that the one or more PUSCH transmissions are performed based on a frequency hopping scheme.

10. The method of claim 9, wherein the frequency hopping scheme is an intra-slot frequency hopping scheme for the one or more PUSCH transmissions in the SBFD symbols.

11. The method of claim 9, wherein the first start PRB in the second hop is determined based on S=U+(K−U−O)mod L, S denotes an index of the first start PRB in the second hop, U denotes an index of a start PRB of UL usable PRBs, K denotes an index of the first start PRB in the first hop, O denotes a frequency offset, and L denotes a number of PRBs included in the UL usable PRBs.

12. The method of claim 11, wherein when an SBFD transmission/reception configuration 2 is indicated to the terminal, K denotes a PRB index after the frequency offset from a start of a UL active bandwidth part (BWP).

13. A terminal comprising at least one processor, wherein the at least one processor causes the terminal to perform:
receiving, from a base station, scheduling information for a plurality of physical uplink shared channel (PUSCH) transmissions across subband full-duplex (SBFD) symbols and non-SBFD (N-SBFD) symbols;
determining, based on the scheduling information, a first start physical resource block (PRB) for one or more PUSCH transmissions among the plurality of PUSCH transmissions in the SBFD symbols; and
transmitting the one or more PUSCH transmissions to the base station using a first frequency resource based on the first start PRB in the SBFD symbols.

14. The terminal of claim 13, wherein the at least one processor further causes the terminal to perform:
determining, based on the scheduling information, a second frequency resource for at least one PUSCH transmission among the plurality of PUSCH transmissions in the N-SBFD symbols; and
transmitting the at least one PUSCH transmission to the base station using the second frequency resource of the N-SBFD symbols.

15. The terminal of claim 14, wherein a size of the first frequency resource is same as a size of the second frequency resource, and the first start PRB of the first frequency resource is different from a second start PRB of the second frequency resource.

16. The terminal of claim 14, wherein the first start PRB is determined based on S=U+(N+O) mod A, S denotes an index of the first start PRB, U denotes an index of a start PRB of uplink (UL) usable PRBs, N denotes an index of a second start PRB of the second frequency resource in the N-SBFD symbols, O denotes a frequency offset, and A denotes a number of PRBs included in the UL usable PRBs.

17. The terminal of claim 16, wherein the frequency offset is independently configured for the terminal according to a type of a configured grant (CG) PUSCH transmission.

18. The terminal of claim 13, wherein in the determining of the first start PRB, the at least one processor further causes the terminal to perform: determining the first start PRB in a first hop or the first start PRB in a second hop based on that the one or more PUSCH transmissions are performed based on a frequency hopping scheme.

19. The terminal of claim 18, wherein the first start PRB in the second hop is determined based on S=U+(K−U−O) mod L, S denotes an index of the first start PRB in the second hop, U denotes an index of a start PRB of UL usable PRBs, K denotes an index of the first start PRB in the first hop, O denotes a frequency offset, and L denotes a number of PRBs included in the UL usable PRBs.

20. The terminal of claim 19, wherein when an SBFD transmission/reception configuration 2 is indicated to the terminal, K denotes a PRB index after the frequency offset from a start of a UL active bandwidth part (BWP).
